(19) United States
(12) Patent Application Publication
(10) Pub. No.: US 2024/0278422 A1
(43) Pub. Date: Aug. 22, 2024

(54) MOVING APPARATUS AND MOVING APPARATUS CONTROL METHOD

(71) Applicant: SONY GROUP CORPORATION, TOKYO (JP)

(72) Inventors: ATSUSHI SAKAMOTO, TOKYO (JP); TOSHIMITSU KAI, TOKYO (JP)

(21) Appl. No.: 18/568,335

(22) PCT Filed: Jan. 27, 2022
(86) PCT No.: PCT/JP2022/003021

§ 371 Date: Dec. 8, 2023

(30) Foreign Application Priority Data
Jun. 17, 2021 (JP) 2021-100692

(51) Int. Cl. B25J 9/16; B62D 57/032; G06V 10/762; G06V 10/764; G06V 20/50

(52) U.S. Cl. CPC B25J 9/163; G06V 10/762; G06V 10/764; G06V 20/50; B62D 57/032

(57) ABSTRACT

A suitable posture according to a shape of a traveling surface of a robot can be stored in a storage, the suitable posture according to the shape of the traveling surface can be acquired from the storage when the robot is to be stopped, and posture control can be performed to stop the robot. A suitable stop posture analyzer that analyzes the suitable stop posture of a walking robot executes processing of analyzing the shape of the traveling surface of the walking robot, stop posture analysis processing of analyzing stop postures according to the shape of the traveling surface, stop posture evaluation value calculation processing of calculating evaluation values of the stop postures, and processing of recording, in the storage, a stop posture having a highest evaluation value among the stop postures according to the traveling surface shape. Furthermore, a stop control unit acquires the suitable stop posture corresponding to a traveling surface shape clustering group from the storage, and performs posture control to match a posture of the robot to the suitable stop posture and stop the robot.

### TECHNICAL FIELD

The present disclosure relates to a moving apparatus and a moving apparatus control method. Specifically, the present disclosure relates to a moving apparatus and a moving apparatus control method that enable control to stop a walking (leg-driven) robot such as a four-leg robot that travels by moving a plurality of legs in a more suitable posture according to a shape of a traveling surface on various traveling surfaces.

### BACKGROUND ART

Examples of a walking (leg-driven) robot that moves by moving legs (leg portions) back and forth include various robots such as a four-legged robot and a six-legged robot.

In a case where such a walking (leg-driven) robot stops, the robot needs to be in a state where at least three legs are landed on the traveling surface.

In some cases, the robot travels not only on a flat surface but also on a traveling surface having various different shapes such as an inclined surface and a staircase, for example. The walking (leg-driven) robot cannot stop in a stable posture unless the arrangement of each foot and the posture of the robot are changed in accordance with the shape of the traveling surface.

An example of a conventional technique that discloses posture control of a walking robot is Patent Document 1 (Japanese Patent No. 3687076).

Patent Document 1 discloses a technique for controlling the posture to a posture that decreases consumed energy in a stationary posture. The robot is configured to measure the consumed energy of the robot to calculate an evaluation reference value, search for a posture that decreases the consumed energy when the robot is in a stationary state, control the posture to that posture, and stop the robot.

For example, when a stationary command is input from a controller to the robot during traveling, the robot stops at the position, and shifts to a stop posture with less energy consumption calculated in advance and stops.

However, this method is a method that can be used only in a case where the traveling surface of the walking robot travels on a limited shape of the traveling surface such as a flat surface for which a stop posture with low energy consumption is calculated.

For example, there is a problem that the method cannot be used in a case where the robot is traveling on a traveling surface having various different shapes such as an inclined surface and a staircase.

Since a stable posture at the time of stopping the robot varies depending on the shape of the traveling surface, there is a limit to determination of the stop posture in advance.

In addition, in a case where a walking (leg-driven) robot stops as described above, the robot needs to be in a state where at least three legs are landed on the traveling surface. A polygon configured by three or more landing points is referred to as support polygon.

After the support polygon is formed, even if an attempt is made to change the posture to a posture that decreases the consumed energy in a stationary state, there is a possibility that the robot falls down when the posture is changed depending on the shape of the traveling surface.

In addition, a walking (leg-driven) robot performs control to change the arrangement of the legs by driving a driving motor attached to each leg. However, for example, in a case where a failure of a motor of one leg causes the robot to take a posture calculated in advance in which consumed energy decreases, a heat generation amount of the motor increases, and it may be difficult to change to the posture.

In such a manner, in order to stably stop the robot, processing in consideration of the shape of the traveling surface of the robot and the state of the robot is required.

### CITATION LIST

### Patent Document

Patent Document 1: Japanese Patent No. 3687076

### SUMMARY OF THE INVENTION

### Problems to be Solved by the Invention

The present disclosure has been made in view of the above problems, for example, and an object of the present disclosure is to provide a moving apparatus and a moving apparatus control method that achieves control for stopping a walking (leg-driven) robot in a suitable posture according to a shape of a traveling surface and a state of the robot.

### Solution to Problems

A first aspect of the present disclosure is
a moving apparatus including a suitable stop posture analyzer that analyzes a suitable stop posture of a walking robot, in which
the suitable stop posture analyzer includes
a traveling surface shape analyzer that analyzes a shape of a traveling surface of the walking robot,
a stop posture analyzer that analyzes stop postures of the walking robot according to the shape of the traveling surface,
a stop posture evaluation value calculator that calculates evaluation values of the stop postures analyzed by the stop posture analyzer, and
a suitable stop posture record updater that records, in a storage, a stop posture having a highest evaluation value among the stop postures of the walking robot according to the shape of the traveling surface.

Furthermore, a second aspect of the present disclosure is
a moving apparatus control method executed in a moving apparatus including
a suitable stop posture analyzer that analyzes a suitable stop posture of a walking robot, the method including,
by the suitable stop posture analyzer,
traveling surface shape analysis processing of analyzing a shape of a traveling surface of the walking robot,
stop posture analysis processing of analyzing stop postures of the walking robot according to the shape of the traveling surface,
stop posture evaluation value calculation processing of calculating evaluation values of the stop postures analyzed in the stop posture analysis processing, and
suitable stop posture record updating processing of recording, in a storage, a stop posture having a highest evaluation value among the stop postures of the walking robot according to the shape of the traveling surface.

Other objects, features, and advantages of the present disclosure will become apparent from a more detailed description based on an embodiment of the present disclosure described later and the accompanying drawings. Note that a system herein described is a logical set configuration of a plurality of devices, and is not limited to a system in which devices with respective configurations are in the same housing.

A configuration of an embodiment of the present disclosure achieves a configuration in which a suitable posture according to a shape of a traveling surface of a robot is stored in a storage, the suitable posture according to the shape of the traveling surface is acquired from the storage when the robot is to be stopped, and posture control is performed to stop the robot.

Specifically, for example, a suitable stop posture analyzer that analyzes the suitable stop posture of a walking robot executes processing of analyzing the shape of the traveling surface of the walking robot, stop posture analysis processing of analyzing stop postures according to the shape of the traveling surface, stop posture evaluation value calculation processing of calculating evaluation values of the stop postures, and processing of recording, in a storage, a stop posture having a highest evaluation value among the stop postures according to the traveling surface shape. Furthermore, a stop control unit acquires the suitable stop posture corresponding to a traveling surface shape clustering group from the storage, and performs posture control to match a posture of the robot to the suitable stop posture and stop the robot.

This configuration achieves a configuration in which the suitable posture according to the shape of the traveling surface of the robot is stored in the storage, the suitable posture according to the shape of the traveling surface is acquired from the storage when the robot is to be stopped, and the posture control is performed to stop the robot.

Note that the effects herein described are only examples and are not restrictive, and additional effects may also be provided.

### BRIEF DESCRIPTION OF DRAWINGS

FIG. 1 is a diagram for describing a configuration example of a four-legged walking robot as an example of a robot apparatus of the present disclosure.

FIG. 2 is a diagram for describing a configuration example of a motor and a sensor of the four-legged walking robot as an example of the robot apparatus of the present disclosure.

FIG. 3 is a diagram illustrating a control configuration example of a robot apparatus using a user terminal.

FIG. 4 is a diagram for describing a configuration example of a six-legged walking robot as an example of the robot apparatus of the present disclosure.

FIG. 5 is a diagram for describing a configuration example of a motor and a sensor of a motor and a sensor of the six-legged walking robot as an example of the robot apparatus of the present disclosure.

FIG. 6 is a diagram for describing an example of a travel environment of the robot apparatus.

FIG. 7 is a diagram for describing an example of the travel environment of the robot apparatus.

FIG. 8 is a diagram for describing an example of the travel environment of the robot apparatus.

FIG. 9 is a diagram for describing an example of the travel environment of the robot apparatus.

FIG. 10 is a diagram for describing an example of the travel environment of the robot apparatus.

FIG. 11 is a diagram for describing an example of the travel environment of the robot apparatus.

FIG. 12 is a diagram describing a configuration example of the robot apparatus of the present disclosure.

FIG. 13 is a diagram for describing a specific example of classification data of a shape of a traveling surface (data for traveling surface shape clustering).

FIG. 14 is a diagram for describing a specific example of an inclination angle of a robot traveling surface.

FIG. 15 is a diagram for describing an example of traveling surface shape analysis data generated by a traveling surface shape analyzer.

FIG. 16 is a diagram for describing a specific example of stop posture data.

FIG. 17 is a diagram for describing an example of a stop posture data analyzed by a stop posture analyzer.

FIG. 18 is a diagram for describing a configuration example of a sensor used to calculate a stop posture evaluation value.

FIG. 19 is a diagram for describing a specific example of an evaluation value calculation algorithm based on a total sum of torques which are detection values of the torque sensors respectively belonging to the motors of the legs.

FIG. 20 is a diagram for describing a specific example of an evaluation value calculation algorithm based on a total sum of temperatures of the motors, which are detection values of temperature sensors respectively belonging to the motors of the legs.

FIG. 21 is a diagram for describing a specific example of an evaluation value calculation algorithm based on a load balance of a leg calculated on the basis of a leg end pressure value which is a detection value of a leg end pressure sensor of each leg.

FIG. 22 is a diagram for describing data in which stop posture data and the stop posture evaluation value calculated by a stop posture evaluation value calculator are associated with each other.

FIG. 23 is a diagram illustrating a data configuration example of “a suitable stop posture and evaluation value data corresponding to a traveling surface shape clustering group” recorded in a storage.

FIG. 24 is a diagram illustrating a flowchart describing a processing sequence executed by the robot apparatus of the present disclosure.

FIG. 25 is a diagram illustrating a flowchart describing a processing sequence executed by the robot apparatus of the present disclosure.

FIG. 26 is a diagram for describing a hardware configuration example of the robot apparatus of the present disclosure.

### MODE FOR CARRYING OUT THE INVENTION

Hereinafter, details of a moving apparatus and a moving apparatus control method of the present disclosure will be described with reference to the drawings. Note that the description will be made in accordance with the following items.
1. Overview of robot apparatus of present disclosure
2. Specific example of travel environment of robot apparatus
3. Configuration example of robot apparatus of present disclosure
4. Sequence of processing executed by robot apparatus of present disclosure
5. Other embodiments
6. Hardware configuration example of robot apparatus of present disclosure
7. Summary of configuration of present disclosure

### 1. Overview of Robot Apparatus of Present Disclosure

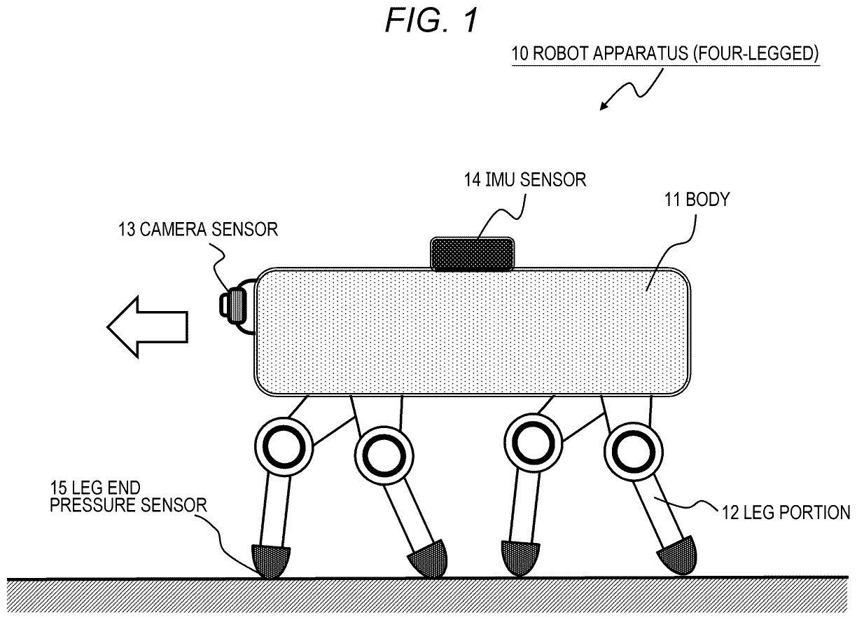

First, an overview of a robot apparatus of the present disclosure will be described with reference to FIG. 1 and the subsequent drawings.

FIG. 1 is a diagram illustrating a robot apparatus 10 as an example of a moving apparatus of the present disclosure.

The robot apparatus 10 illustrated in FIG. 1 is a four-legged walking robot having two legs on the front and two legs on the rear.

It is possible to perform leg movement, that is, walking travel by individually lifting each of the four legs and moving the legs back and forth.

As illustrated in FIG. 1, the robot apparatus 10 includes a body (trunk) 11 and four leg portions 12.

Furthermore, a plurality of sensors is attached to the robot apparatus 10. FIG. 1 illustrates a camera sensor 13, an inertial measurement unit (IMU) sensor 14, and a leg end pressure sensor 15.

The camera sensor 13 captures an image of a surrounding environment of the robot apparatus 10. The captured image is used to analyze a position of an obstacle, a shape of a robot traveling surface, and the like.

The IMU sensor 14 is an inertial measurement device, and acquires information for analyzing an inclination, acceleration, moving speed, and the like of the robot apparatus 10.

The leg end pressure sensor 15 is attached to an end of each of the four legs, and is used to measure whether or not each leg is landed and further measure a weight load amount of each leg in a landed state.

Note that the example of the sensors illustrated in FIG. 1 is an example, and a configuration in which various other sensors are attached can be used. For example, any of a stereo camera, an omnidirectional camera, an infrared camera, a light detection and ranging (LiDAR) sensor, a time of flight (TOF) sensor, or the like, or a combination thereof can be used.

Note that both the LiDAR and TOF sensors are sensors capable of measuring an object distance.

Furthermore, a temperature sensor for measuring a temperature of a motor of each leg corresponding to a drive unit of the robot apparatus 10, a torque sensor for measuring a torque (load) of the motor of each leg, and the like are also individually attached to each motor unit.

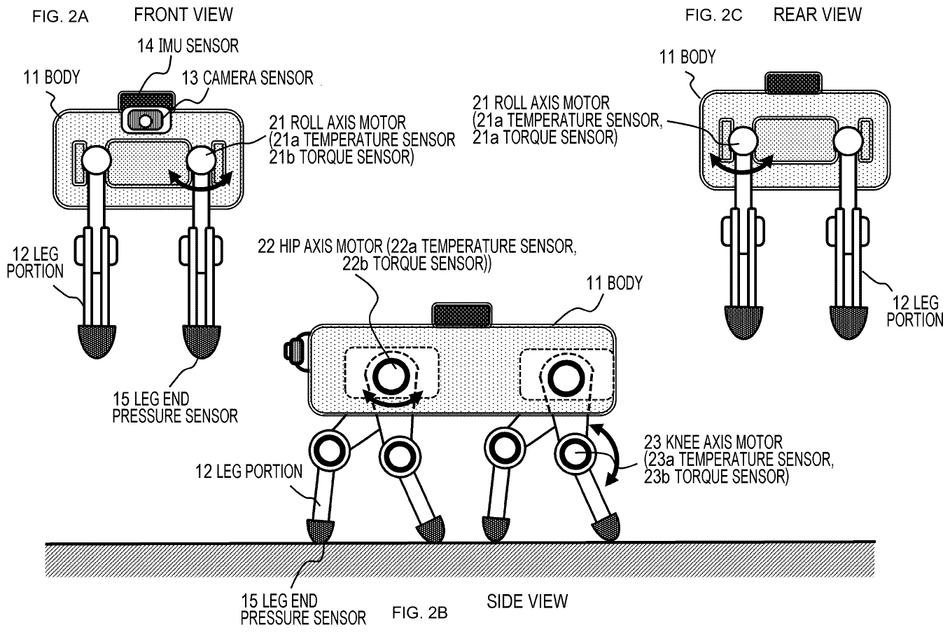

A detailed configuration example of the robot apparatus 10 illustrated in FIG. 1 will be described with reference to FIG. 2.

FIG. 2 includes three diagrams illustrating
(a) a front view,
(b) a side view, and
(c) a rear view,
of the robot apparatus 10 illustrated in FIG. 1.

As understood from (a) the front view and (c) the rear view, an upper end of each of the leg portions 12 with respect to the body 11, that is, a leg attachment portion is pivotable in the left-right direction (around a roll axis) when viewed from the front surface and the rear surface of the robot. This pivot is performed by driving of a roll axis motor 21.

Furthermore, as understood from (b) the side view, an upper end portion of each of the leg portions 12 is also pivotable in the front-rear direction. This pivot in the front-rear direction is performed by driving of a hip axis motor 22.

In such a manner, the upper end portion of each of the leg portions 12 is pivotable with respect to the body 11 in both the front-rear direction and the left-right direction.

Furthermore, as understood from (b) the side view, a so-called knee joint portion is provided in a middle of each leg, and a lower half of each of the leg portions 12 is pivotable in the front-rear direction with respect to an upper portion of each leg. This pivot is performed by driving of a knee axis motor 23.

To a motor of each leg corresponding to a drive unit of the robot apparatus 10, a temperature sensor for measuring a temperature and a torque sensor for measuring a torque (load) of the motor of each leg are individually attached.

That is, a temperature sensor 21a and a torque sensor 21b are individually provided for each of the four roll axis motors 21 for the respective four legs, and are configured to measure and output a heat generation amount and a load (torque) at the time of driving the roll axis motor 21 when each leg is pivotally driven in the left-right direction.

In addition, a temperature sensor 22a and a torque sensor 22b are individually provided for each of the four hip axis motors 22 for the respective four legs, and are configured to measure and output a heat generation amount and a load (torque) at the time of driving the hip axis motor 22 when each leg is pivotally driven in the front-rear direction.

Similarly, a temperature sensor 23a and a torque sensor 23b are individually provided for each of the four knee axis motors 23 for the respective four legs, and are configured to measure and output a heat generation amount and a load (torque) at the time of driving the knee axis motor 23 when a lower half of each leg is pivotally driven in the front-rear direction.

Detection values of the temperature sensor and the torque sensor belonging to each motor are input to a control unit inside the robot apparatus 10, and are used, for example, for calculation of an evaluation value of stability of a stop posture and the like when the robot apparatus stops.

Details of these processing will be described later.

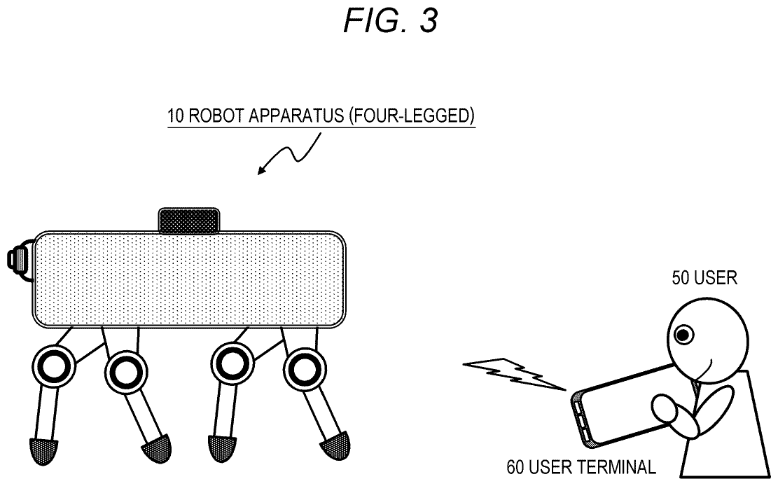

Although the robot apparatus 10 can autonomously travel under the control of the robot apparatus 10 itself, for example, as illustrated in FIG. 3, the robot apparatus can also travel by receiving an instruction command such as start of traveling, stop of traveling, or course change from a user terminal 60 operated by a user 50.

Note that a control device (information processing device) for controlling the robot is mounted on the body 11 of the robot apparatus 10. The control device inputs detection signals from various sensors and encoders attached to the robot apparatus 10, analyzes a position (three-dimensional position) and movement of each leg by analyzing the input signals, and drives and controls each leg on the basis of the analysis result.

Note that the robot apparatus 10 described with reference to FIGS. 1 to 3 is a four-legged walking robot, but the number of legs can be variously set.

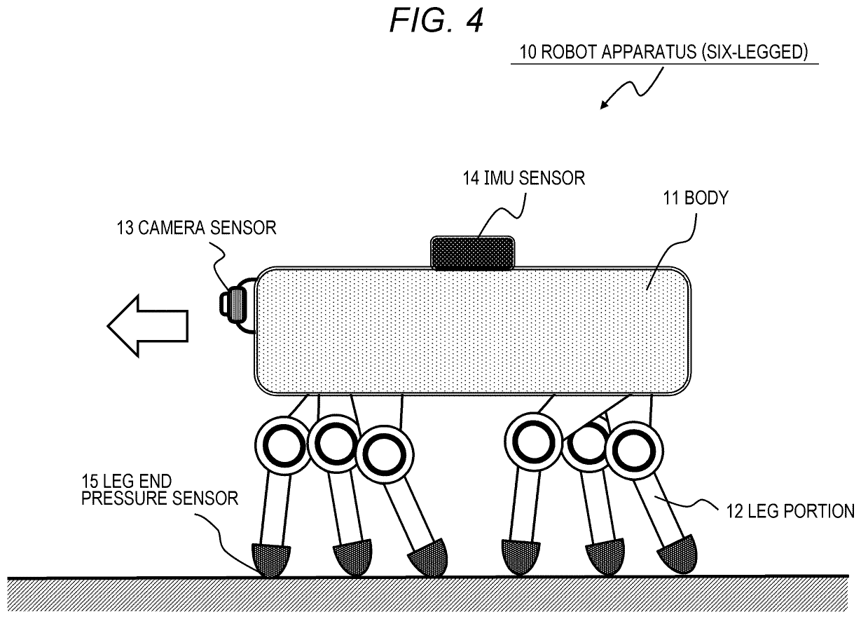

For example, FIG. 4 illustrates a configuration example of a six-legged robot apparatus 10.

The robot apparatus 10 illustrated in FIG. 4 is a configuration example of a six-legged walking robot having three legs at the front and three legs at the rear.

It is possible to perform walking travel by lifting each of the legs and moving the legs back and forth.

Similarly to the four-legged robot apparatus 10 described above with reference to FIGS. 1 to 3, the robot apparatus 10 illustrated in FIG. 4 also includes a body 11 and a leg portion 12, and a plurality of sensors is attached to the robot apparatus. FIG. 4 illustrates a camera sensor 13, an inertial measurement unit (IMU) sensor 14, and a leg end pressure sensor 15.

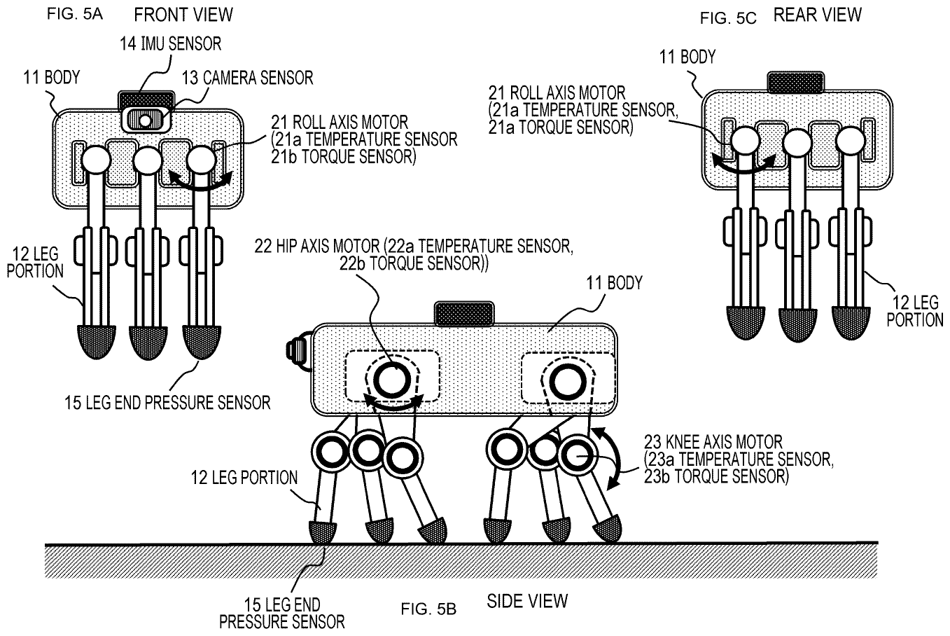

A detailed configuration of the robot apparatus 10 illustrated in FIG. 4 will be described with reference to FIG. 5.

FIG. 5 includes three diagrams illustrating
(a) a front view,
(b) a side view, and
(c) a rear view,
of the robot apparatus 10 illustrated in FIG. 4.

Similarly to the above description with reference to FIG. 2, the upper end portion of each of the leg portions 12 is pivotable with respect to the body 11 in both the front-rear direction and the left-right direction.

The pivot in the left-right direction is performed by driving of a roll axis motor 21.

The pivot in the front-rear direction is performed by driving of a hip axis motor 22.

Furthermore, as understood from (b) the side view, a so-called knee joint portion is provided in a middle of each leg, and a lower half of each of the leg portions 12 is pivotable in the front-rear direction with respect to an upper portion of each leg. This pivot is performed by driving of a knee axis motor 23.

To a motor of each leg corresponding to a drive unit of the robot apparatus 10, a temperature sensor for measuring a temperature and a torque sensor for measuring a torque (load) of the motor of each leg are individually attached.

That is, a temperature sensor 21a and a torque sensor 21b are individually provided for each of the six roll axis motors 21 for the respective six legs.

In addition, a temperature sensor 22a and a torque sensor 22b are individually provided for each of the six hip axis motors 22 for the respective six legs.

Similarly, a temperature sensor 23a and a torque sensor 23b are individually provided for each of the six knee axis motors 23 for each of the six legs.

These sensors measure a heat generation amount and a load (torque) of each motor when each leg is driven.

Detection values of the temperature sensor and the torque sensor belonging to each motor are input to a control unit inside the robot apparatus 10, and are used, for example, for calculation of an evaluation value of stability of a stop posture and the like when the robot apparatus stops.

Details of these processing will be described later.

The configuration example of the robot apparatus 10 of the present disclosure has been described with reference to FIGS. 1 to 5.

The robot apparatus of the present disclosure is a walking robot capable of performing leg movement, that is, walking travel by lifting a plurality of legs and moving the legs back and forth in such a manner.

### 2. Specific Example of Travel Environment of Robot Apparatus

Next, a specific example of a travel environment of the robot apparatus will be described.

Note that, hereinafter, an embodiment to which the four-legged robot 10 described with reference to FIGS. 1 to 3 is applied will be described as a representative example of the robot apparatus of the present disclosure.

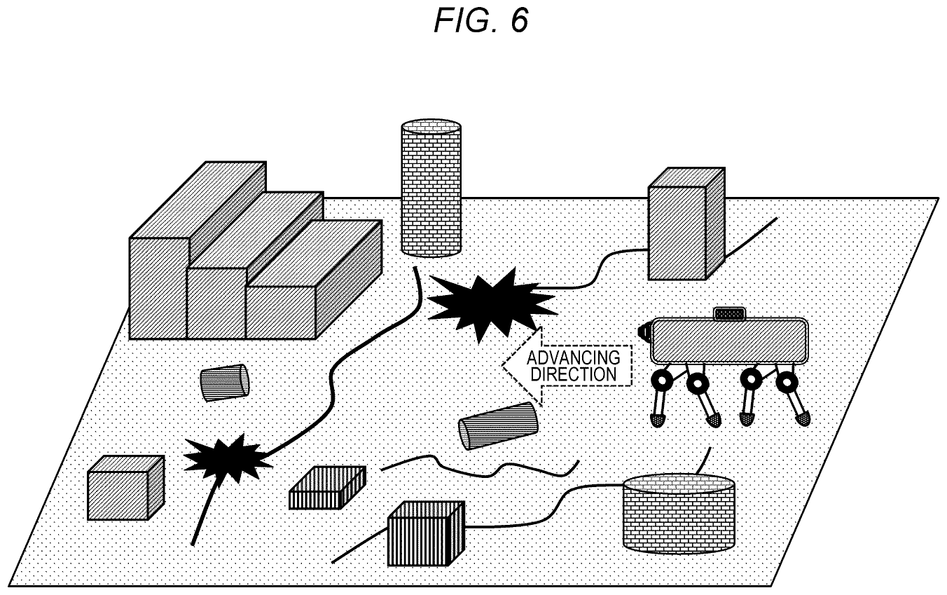

FIG. 6 is a diagram illustrating an example of an environment in which the four-legged robot 10 travels.

As an environment in which the four-legged robot 10 moves, for example, there are various obstacles as illustrated in FIG. 6. In addition, the traveling surface is not limited to a flat surface, and there are various kinds of traveling surfaces such as a rough surface, a stepped surface, an inclined surface, and a stair.

The four-legged robot 10 repeats traveling and stopping while avoiding obstacles in such an environment, for example. There are various environments of the traveling surface at the time of stopping. It is necessary to stop at positions of various traveling surfaces such as a rough surface, a stepped surface, and an inclined surface.

As described above, the robot apparatus 10 needs to have at least three legs landed on the traveling surface in order to stop stably. A polygon configured by three or more landing points is referred to as support polygon.

For example, in a case where the robot apparatus 10 cannot form a support polygon, there is a possibility that the robot apparatus loses balance and falls down to cause damage or failure.

In a case where the robot apparatus 10 stops in the environment as illustrated in FIG. 6, it is necessary to perform control for setting the posture of the robot apparatus to a stable posture selected in accordance with the shape of the traveling surface at a stop position, that is, a leg arrangement and the robot posture capable of maintaining a stable stationary state.

However, the leg arrangement and the robot posture capable of maintaining a stable stationary state differ depending on the shape of the traveling surface at the position where the robot apparatus 10 stops.

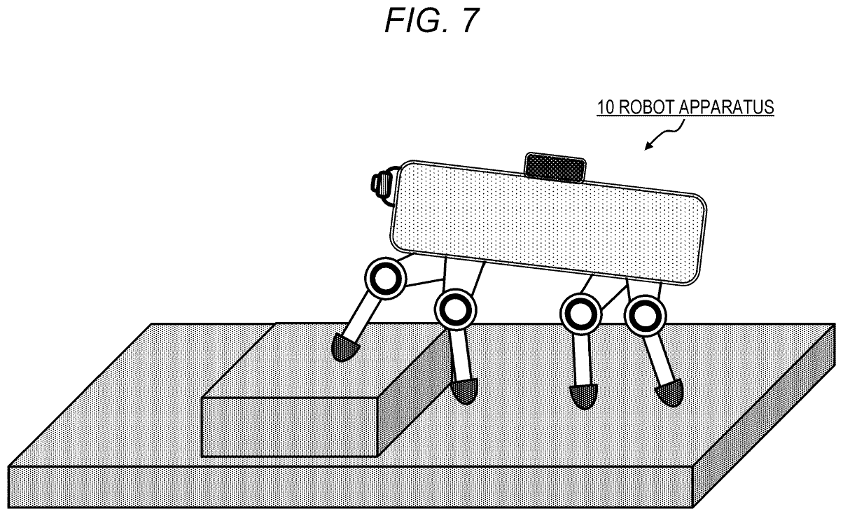

A plurality of examples of the shape of the traveling surface at the position where the robot apparatus 10 stops will be described with reference to FIG. 7 and the subsequent drawings.

FIG. 7 is an example of a traveling surface having a higher step ahead the robot apparatus 10 in an advancing direction.

As illustrated in FIG. 7, at a time when the robot apparatus 10 places the right front leg on the position of the higher step, in some cases, the robot apparatus receives a stop command from the user terminal 60 operated by the user 50 described with reference to FIG. 3, for example.

In this case, the robot apparatus 10 of the present disclosure determines a leg arrangement capable of forming the support polygon configured by landing at least three legs at a robot position illustrated in FIG. 7, that is, a position where the robot apparatus 10 places the right front leg on the position of the higher step, and further determines a robot posture capable of maintaining a stable stationary state, such as a highly stable inclination and center of gravity position of the robot according to the leg arrangement.

Furthermore, the robot apparatus 10 of the present disclosure executes posture control for changing the robot posture to the determined robot posture and performs processing of stopping the robot apparatus 10.

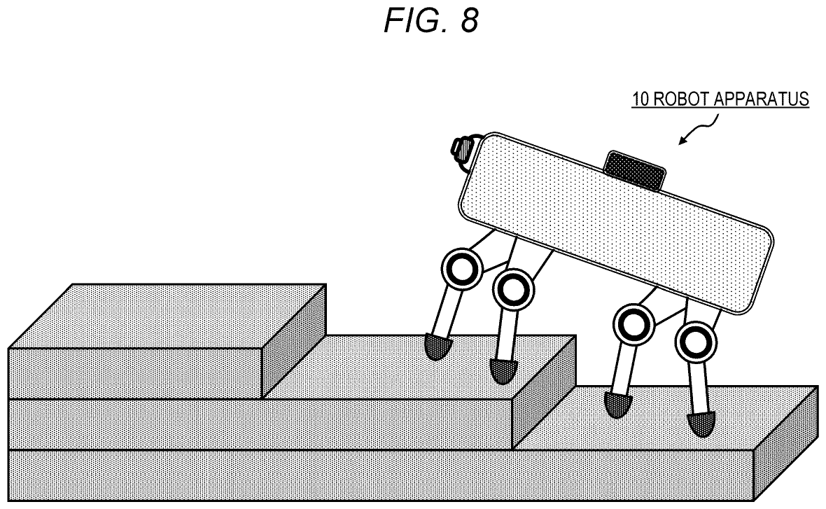

FIG. 8 illustrates an example different from FIG. 7. The example illustrated in FIG. 8 shows a case where a staircase exists ahead the robot apparatus 10 in the advancing direction, and the robot apparatus 10 receives a stop command at the time when the robot apparatus 10 places the right front leg and the left front leg on the position of the higher step.

In this case, the robot apparatus 10 of the present disclosure determines a leg arrangement capable of forming the support polygon configured by landing at least three legs at a robot position illustrated in FIG. 8, that is, a position where the robot apparatus 10 places the right front leg and the left front leg on the position of the higher step, and further determines a robot posture capable of maintaining a stable stationary state, such as a highly stable inclination and center of gravity position of the robot according to the leg arrangement.

Furthermore, the robot apparatus 10 of the present disclosure executes posture control for changing the robot posture to the determined robot posture and performs processing of stopping the robot apparatus 10.

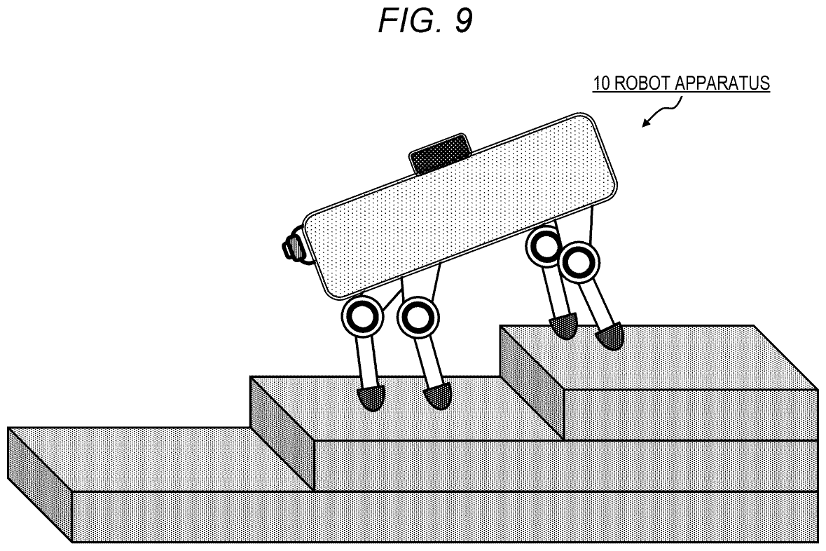

FIG. 9 is a further different example. The example illustrated in FIG. 9 shows a case where a descending staircase exists ahead the robot apparatus 10 in the advancing direction, and the robot apparatus 10 receives a stop command at the time when the robot apparatus 10 places the right front leg and the left front leg on the position of a lower step.

In this case, the robot apparatus 10 of the present disclosure determines a leg arrangement capable of forming the support polygon configured by landing at least three legs at a robot position illustrated in FIG. 9, that is, a position where the robot apparatus 10 places the right front leg and the left front leg on the position of the lower step, and further determines a robot posture capable of maintaining a stable stationary state, such as a highly stable inclination and center of gravity position of the robot according to the leg arrangement.

Furthermore, the robot apparatus 10 of the present disclosure executes posture control for changing the robot posture to the determined robot posture and performs processing of stopping the robot apparatus 10.

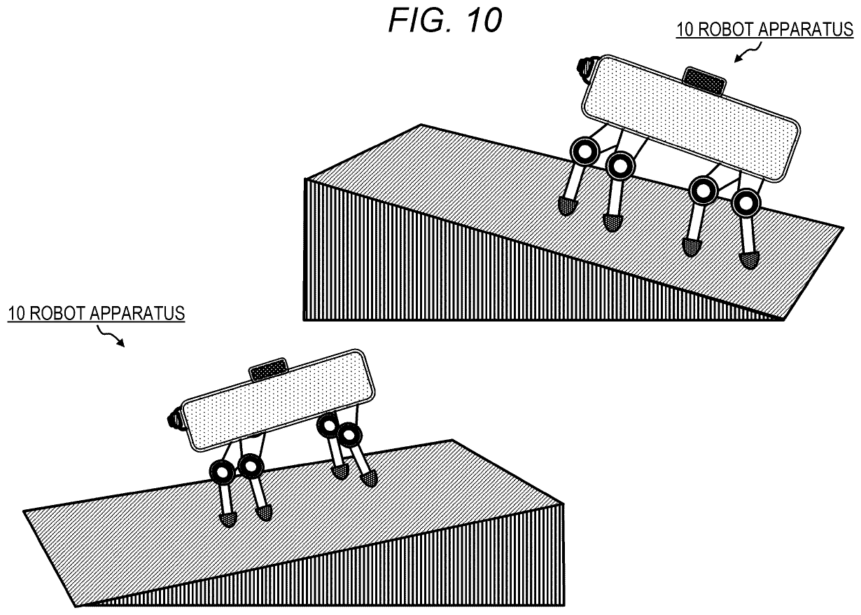

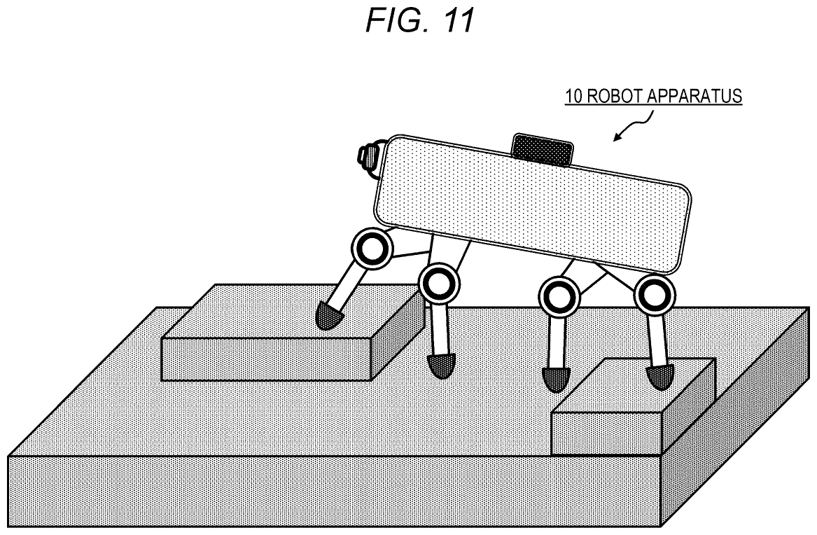

In some other cases, the robot apparatus 10 receive a stop command at a position with various different shapes of the traveling surface, such as, for example, an inclined surface as illustrated in FIG. 10 or a rough traveling surface as illustrated in FIG. 11.

The robot apparatus 10 of the present disclosure performs processing of determining the robot posture including the leg arrangement capable of maintaining a stable stationary state in accordance with each shape of the traveling surfaces, performing the posture control for changing the robot posture to the determined robot posture, and stopping.

In such a manner, there is a possibility that the robot apparatus 10 travels on traveling surfaces having various shapes, and receives stop commands at various timings. Therefore, the robot apparatus needs to stop on traveling surfaces having various shapes.

However, as described above, the robot posture that can maintain a stable stationary state differs depending on the shape of the traveling surface.

When receiving the stop command during traveling, the robot apparatus 10 needs to perform processing of determining a highly stable posture according to the shape of the traveling surface, changing its posture to the determined posture, and stopping. However, it takes time to analyze the shape of the traveling surface at the time when the robot apparatus receives the stop command and to calculate an optimum stable posture according to the analysis result.

When such a time loss occurs, the robot apparatus 10 might not be able to be stopped at a target position. On the other hand, when the robot apparatus 10 is forcibly stopped at the target position, the robot apparatus 10 might stop in an unstable posture and fall.

The present disclosure solves such a problem, and executes processing of causing the robot apparatus 10 to travel while analyzing the shape of the traveling surface, causing the robot apparatus 10 to calculate a highly stable stop posture according to the shape of the traveling surface, and registering information of the calculated stop posture and an evaluation value of the information in the storage.

In a case where the robot apparatus 10 receives the stop command, processing is performed in which stop posture information having a high evaluation value according to the shape of the traveling surface at the time of receiving the stop command is acquired from the storage, the stop posture is set, and the robot apparatus is stopped.

By performing such processing, it is possible to immediately execute posture control to different stable stop postures according to various shapes of traveling surfaces, and stably stop the robot apparatus 10 at the target position without a time loss.

Hereinafter, specific examples of the configuration and processing of the robot apparatus of the present disclosure will be described.

### 3. Configuration Example of Robot Apparatus of Present Disclosure

Next, a configuration example of the robot apparatus of the present disclosure will be described.

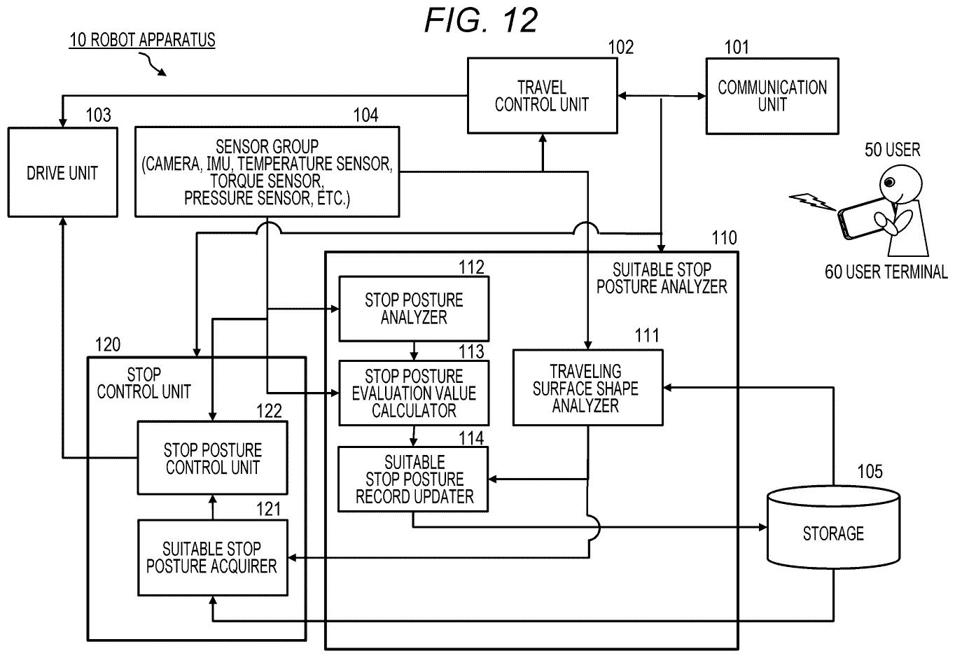

FIG. 12 is a block diagram illustrating a configuration example of the robot apparatus 10 of the present disclosure.

As illustrated in FIG. 12, the robot apparatus 10 of the present disclosure includes a communication unit 101, a travel control unit 102, a drive unit 103, a sensor group 104, a storage 105, a suitable stop posture analyzer 110, and a stop control unit 120.

Note that the suitable stop posture analyzer 110 includes a traveling surface shape analyzer 111, a stop posture analyzer 112, a stop posture evaluation value calculator 113, and a suitable stop posture record updater 114, and the stop control unit 120 includes a suitable stop posture acquirer 121 and a stop posture control unit 122.

Note that the storage 105 records each of the following data:
(1) data for traveling surface shape clustering; and
(2) a suitable stop posture and evaluation value data corresponding to a traveling surface shape clustering group.

These data will be described in detail later.

Note that processors such as a traveling surface shape analyzer and a traveling posture control unit also exist in the travel control unit 102. However, since the conventional configurations are applicable, these processors are not used for the processing of the present disclosure and are omitted.

The processing of the present disclosure is processing of calculating a stop posture and a posture evaluation value with high stability according to the shape of the traveling surface and recording the stop posture and the posture evaluation value in the storage 105, and processing of controlling the stop posture of the robot apparatus 10 to which the data recorded in the storage 105 is applied. A subject that executes these processing is the suitable stop posture analyzer 110 and the stop control unit 120 of the robot apparatus 10 illustrated in FIG. 12.

Each component of the robot apparatus 10 illustrated in FIG. 12 will be described.

The communication unit 101 executes, for example, communication with the user terminal 60 held by the user 50.

The user terminal 60 outputs a travel start command and a stop command to the robot apparatus 10. Alternatively, the user terminal 60 also provides travel route information and the like.

The communication unit 101 of the robot apparatus 10 receives these information from the user terminal 60, and outputs the information to the travel control unit 102 and the suitable stop posture analyzer 110.

The travel control unit 102 and the suitable stop posture analyzer 110 execute travel control and stop control in accordance with reception information from the user terminal 60.

The travel control unit 102 controls the drive unit 103 in accordance with the reception information from the user terminal 60 to cause the robot apparatus 10 to travel.

Note that, as described above, the travel control unit 102 includes processors such as a traveling surface shape analyzer that analyzes the shape of the robot traveling surface, and a traveling posture control unit that controls the robot posture such as the leg arrangement during traveling of the robot and an orientation and inclination of the robot. However, since the conventional configurations are applicable, these processors are not used for the processing of the present disclosure and will not be described.

Specifically, the drive unit 103 includes, for example, a motor for driving each leg of the robot apparatus 10, and the like. The motor includes motors such as the roll axis motor 21, the hip axis motor 22, and the knee axis motor 23 described above with reference to FIG. 2 and the like.

The sensor group 104 includes a camera, an IMU, a temperature sensor, a torque sensor, a pressure sensor, and the like.

The camera, the IMU, and the pressure sensor are the sensors described with reference to FIGS. 1, 2, and the like.

As described above with reference to FIG. 1 and the like, the camera sensor 13 illustrated in FIG. 1 captures an image of the surrounding environment of the robot apparatus 10. The captured image is used to analyze a position of an obstacle, a shape of a robot traveling surface, and the like.

Furthermore, the IMU sensor 14 illustrated in FIG. 1 is an inertial measurement device, and acquires information for analyzing an inclination, acceleration, moving speed, and the like of the robot apparatus 10. The leg end pressure sensor 15 is attached to an end of each of the four legs, and is used to measure whether or not each leg is landed and further measure a weight load amount of each leg in a landed state.

The temperature sensor and the torque sensor are the sensors described above with reference to FIGS. 2 and the like.

That is, the temperature sensor 21a and the torque sensor 21b are individually provided for each of the roll axis motors 21 of the respective legs as described with reference to FIG. 2.

In addition, a temperature sensor 22a and a torque sensor 22b are individually provided for each of the hip axis motors 22 for the respective legs.

Similarly, the temperature sensor 23a and the torque sensor 23b are individually provided for each of the knee axis motors 23 for the respective legs.

These sensors measure a heat generation amount and a load (torque) of each motor when each leg is driven.

Detection values of the sensors constituting the sensor group 104 are input to the travel control unit 102 and the suitable stop posture analyzer 110, and are used for travel control processing and stop control processing.

Note that various other sensors can be used as the sensors constituting the sensor group 104. For example, any of a stereo camera, an omnidirectional camera, an infrared camera, a light detection and ranging (LiDAR) sensor, a time of flight (TOF) sensor, or the like, or a combination thereof can be used.

Next, each component of the suitable stop posture analyzer 110 will be described.

The suitable stop posture analyzer 110 executes processing of calculating a stop posture and a posture evaluation value with high stability according to the shape of the traveling surface and recording the stop posture and the posture evaluation value in the storage 105.

Note that this processing can be executed without stopping the robot apparatus 10, and can be executed while the robot apparatus 10 is traveling.

The suitable stop posture analyzer 110 includes the traveling surface shape analyzer 111, the stop posture analyzer 112, the stop posture evaluation value calculator 113, and the suitable stop posture record updater 114.

First, processing executed by the traveling surface shape analyzer 111 will be described.

The traveling surface shape analyzer 111 performs processing of analyzing the shape of the traveling surface of the robot apparatus 10.

For example, processing of analyzing the shape of the traveling surface of the robot apparatus 10 is performed on the basis of an image captured by the camera and input from the sensor group 104, the inclination of the robot which is the detection value of the IMU, the landing and a weight amount of each leg detected from the pressure sensor of each leg end, and the like.

Note that traveling surface shape analysis processing executed by the traveling surface shape analyzer 111 of the suitable stop posture analyzer 110 is not highly accurate analysis processing of the traveling surface on which the robot apparatus 10 travels but rough classification processing of the shape of the traveling surface. That is, clustering processing of roughly classifying the type of the shape of the traveling surface on which the robot apparatus 10 is traveling is executed.

The traveling surface shape analyzer 111 refers to data for traveling surface shape clustering stored in the storage 105 and executes the clustering processing of the shape of the traveling surface on which the robot apparatus 10 is traveling.

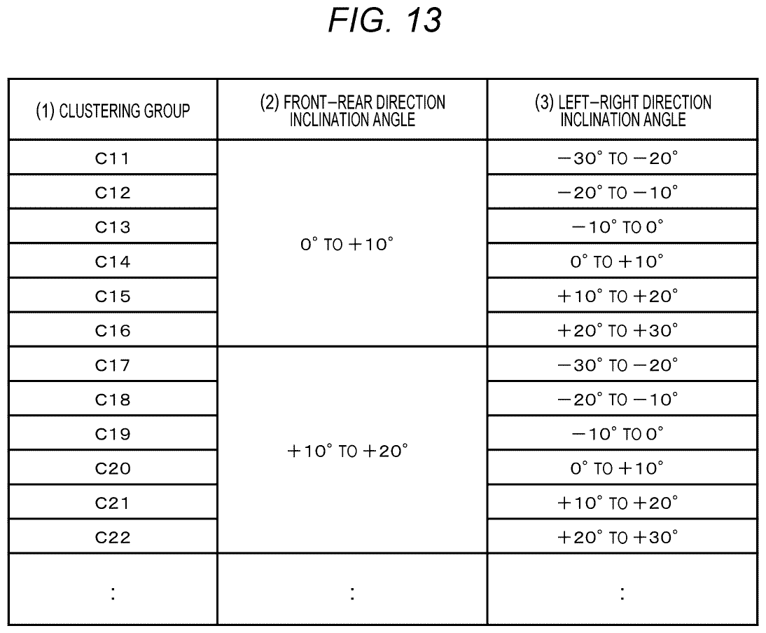

A specific example of classification data of the shape of the traveling surface (data for traveling surface shape clustering) applied to the clustering processing (classification processing) of the shape of the traveling surface executed by the traveling surface shape analyzer 111 will be described with reference to FIG. 13.

FIG. 13 illustrates an example of data applied when the traveling surface shape analyzer 111 performs the clustering processing of the shape of the traveling surface, that is, data for the clustering processing (classification processing) which is classification data of the shape of the traveling surface.

As illustrated in FIG. 13, the data for traveling surface shape clustering stored in the storage 105 includes each data of
(1) a clustering group,
(2) a front-rear direction inclination angle, and
(3) a left-right direction inclination angle.
“(1) The clustering group” indicates an identifier (C11, C12, C13 . . . ) of each clustering group (classification group) of the shape of the traveling surface.
“(2) The front-rear direction inclination angle” indicates an inclination angle in the front-rear direction of the shape of the traveling surface classified into each clustering group.

For example, the clustering groups (C11 to C13) are groups of inclined surface shapes in which the front-rear direction inclination angle of the shape of the traveling surface is in a range of 0° to +10°.

Note that the front-rear direction inclination angle=0° means that the traveling surface of the robot apparatus 10 is horizontal without inclination in the front-rear direction of the robot.

The front-rear direction inclination angle=+10° means that the inclination angle of the traveling surface of the robot apparatus 10 in the front-rear direction of the robot is +10°, that is, there is an inclined surface or a step that has a height in a forward direction in which the robot apparatus 10 advances.

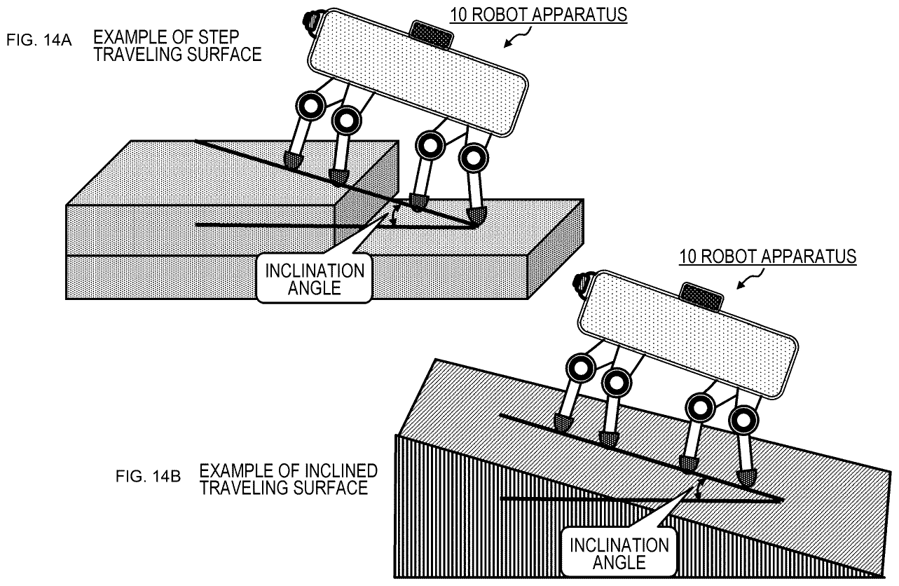

FIG. 14 illustrates a specific example of a traveling surface that has an inclined surface or a step having a height in the forward direction.

FIG. 14(a) is an example of a traveling surface having a step, and FIG. 14(b) is an example of an inclined surface.

For example, the front-rear inclination angle is calculated as an angle between a horizontal line and a straight line connecting the advancing direction of the robot apparatus 10, a landing position of the foremost leg, and a landing position of the rearmost leg.

In this processing example, calculation processing of the “front-rear direction inclination angle” is similarly performed in both the case of the traveling surface having the step illustrated in FIG. 14(a) and the case of the inclined surface having no step illustrated in FIG. 14(b), and the step and the inclined surface are not distinguished from each other.

However, this clustering processing example is an example, and clustering processing in which a step and an inclined surface are distinguished may be performed.
“(2) The front-rear direction inclination angle” and “ (3) the left-right direction inclination angle” of the data for traveling surface shape clustering illustrated in FIG. 13 are set to be calculated on the basis of the landing position (height) of each leg, and are data that do not distinguish between a step and an inclined surface.

Note that, in a case where there is an inclined surface in which the forward direction in which the robot apparatus 10 advances is lowered or there is a step in which the forward direction is lowered, the inclination angle is set to −10° or the like.
“(3) The left-right direction inclination angle” of the data for traveling surface shape clustering illustrated in FIG. 13 corresponds to, for example, an angle between a straight line connecting a landing position of the leftmost leg of the robot apparatus 10 and a landing position of the rightmost leg and the horizontal line.

For example, if the landing position of the leftmost leg and the landing position of the rightmost leg are at the same height, the inclination angle in the left-right direction=0°.

In a case where the landing position of the leftmost leg is higher than the landing position of the rightmost leg, the inclination angle in the left-right direction is a value of (+), and in a case where the landing position of the leftmost leg is lower than the landing position of the rightmost leg, the inclination angle in the left-right direction is a value of (−).

For example, in the data for traveling surface shape clustering illustrated in FIG. 13, the clustering group C11 is a traveling surface in a range of
the front-rear direction inclination angle=0° to +10°, and
the left-right direction inclination angle=−30° to −20°.

For example, the traveling surface shape analyzer 111 performs the processing of analyzing the shape of the traveling surface of the robot apparatus 10 on the basis of an image captured by the camera and input from the sensor group 104, the inclination of the robot which is the detection value of the IMU, the landing and a weight amount of each leg detected from the pressure sensor of each leg end, and the like.

As a result of this analysis processing, in a case where it is determined that the shape of the current traveling surface of the robot apparatus 10 is in the range of the inclination defined in the clustering group C11 described above, that is, in the range of the inclination of
the front-rear direction inclination angle=0° to +10°, and
the left-right direction inclination angle=−30° to −20°,
as a clustering result of the shape of the current traveling surface of the robot apparatus 10, the clustering group of the shape of the traveling surface is determined as the clustering group=C11.

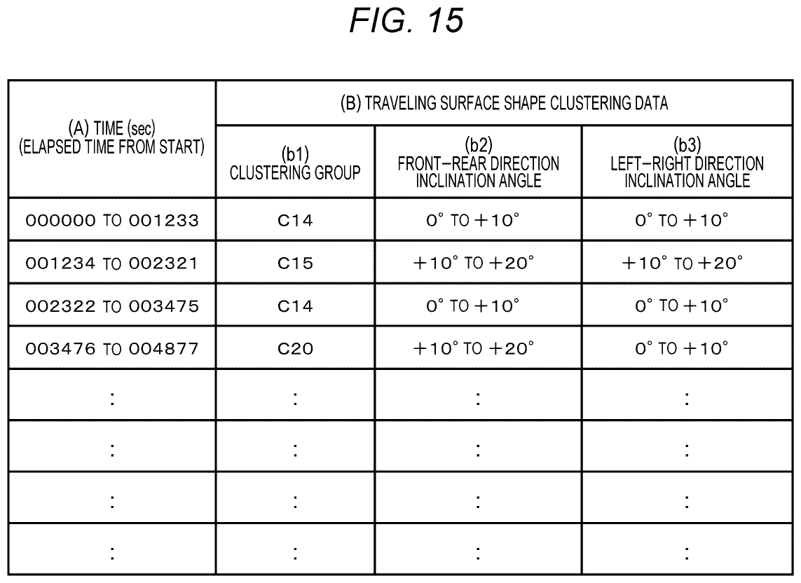

An example of traveling surface shape analysis data generated by the traveling surface shape analyzer 111 will be described with reference to FIG. 15.

FIG. 15 illustrates data corresponding to
(A) time (elapsed time from start) (sec), and
(B) traveling surface shape clustering data.
(B) The traveling surface shape clustering data includes data of
(b1) a clustering group,
(b2) a front-rear direction inclination angle, and
(b3) a left-right direction inclination angle.
“(A) The time (elapsed time from start)” is data indicating an elapsed time from the time of the start of traveling of the robot apparatus 10 in unit of seconds (sec).
“(B) The traveling surface shape clustering data” is traveling surface shape clustering data in a time range indicated by “(A) the time (elapsed time from start)”.
“(B) The traveling surface shape clustering data” includes data of
(b1) a clustering group,
(b2) a front-rear direction inclination angle, and
(b3) a left-right direction inclination angle. The above data is similar to the data described above with reference to FIG. 13.

That is, “(b1) the clustering group” indicates an identifier (C11, C12, C13 . . . ) of each clustering group (classification group) of the shape of the traveling surface.
“(b2) The front-rear direction inclination angle” indicates an inclination angle in the front-rear direction of the shape of the traveling surface corresponding to the clustering group.
“(b3) The left-right direction inclination angle” indicates an inclination angle in the left-right direction of the shape of the traveling surface corresponding to the clustering group.

In the data illustrated in FIG. 15, the first data (elapsed time=000000 to 001233) is the traveling surface shape clustering data for the elapsed time=001233 from the time of the start of traveling of the robot apparatus 10 (elapsed time=000000).

The data indicates that the shape of the traveling surface for the elapsed time from the start of traveling of the robot apparatus 10=000000 to 001233 has the shape of the traveling surface corresponding to the traveling surface shape clustering data indicated by
(b1) the clustering group=C14,
(b2) the front-rear direction inclination angle=0° to +10°, and
(b3) the left-right direction inclination angle=0° to +10°.

The second entry data of the data illustrated in FIG. 15 is the traveling surface shape clustering data for the elapsed time from the start of traveling of the robot apparatus 10=001234 to 002231.

The data indicates that the shape of the traveling surface for the elapsed time from the start of traveling of the robot apparatus 10=001234 to 002231 has the shape of the traveling surface corresponding to the traveling surface shape clustering data indicated by
(b1) the clustering group=C15,
(b2) the front-rear direction inclination angle=+10° to +20°, and
(b3) the left-right direction inclination angle=+10° to +20°.

In such a manner, the traveling surface shape analyzer 111 analyzes the shape of the traveling surface during traveling of the robot apparatus 10. In a case where a change in the shape of the traveling surface occurs, the traveling surface shape analyzer 111 executes processing of analyzing the clustering group corresponding to the changed shape of the traveling surface.

The traveling surface shape clustering data including the clustering group analyzed by the traveling surface shape analyzer 111 is output to the suitable stop posture record updater 114 and the suitable stop posture acquirer 121 of the stop control unit 120.

Next, processing executed by the stop posture analyzer 112 and the stop posture evaluation value calculator 113 will be described.

The stop posture analyzer 112 analyzes the posture of the robot apparatus 10 at the time of stopping, and acquires stop posture information.

The stop posture evaluation value calculator 113 evaluates the stop posture analyzed by the stop posture analyzer 112 and calculates an evaluation value (stop posture evaluation value).

The stop posture analyzer 112 determines whether or not at least three legs are landed and a support polygon is formed while the robot apparatus 10 is traveling. In a case where determining that the support polygon is formed, the stop posture analyzer 112 analyzes the posture at a timing when the support polygon is formed as the “stop posture”.

Furthermore, the stop posture evaluation value calculator 113 calculates an evaluation value of the “stop posture”.

Note that the above processing is executed without stopping the robot apparatus 10.

The stop posture analyzer 112 analyzes, as the “stop posture”, the posture of the robot apparatus 10 at the timing when at least three legs are landed and the support polygon is formed while the robot apparatus 10 is traveling.

When at least three legs are landed and the support polygon is formed, the robot apparatus 10 can be stopped. Thus, the stop posture analyzer 112 analyzes the posture at this timing as the “stop posture” without actually stopping the robot apparatus 10.

The stop posture analyzer 112 acquires detection values of various sensors input from the sensor group 104 at the timing when the support polygon is formed, and analyzes the posture at that timing as the “stop posture”. The stop posture evaluation value calculator 113 further calculates an evaluation value (stop posture evaluation value) by applying a predefined evaluation value calculation algorithm to the “stop posture”.

The stop posture analyzer 112 and the stop posture evaluation value calculator 113 analyze the “stop posture” on the basis of, for example, the inclination of the robot which is a detection value of the IMU, the load of the motor analyzed from the detection values of the temperature sensor and the torque sensor belonging to each motor, the landing and the weight amount of each leg detected from the pressure sensor of each leg end, and the like, and calculate the “stop posture evaluation value”.

The “stop posture” analyzed by the stop posture analyzer 112 includes, for example, each of the following data:
(a) inclination of body (trunk) (inclination in each of front-rear direction and left-right direction);
(b) rotation angle of joint of each leg (=rotation angles about roll axis, pitch axis, and knee axis of each leg); and
(c) whether or not each leg is landed and pressure of leg end.

The stop posture analyzer 112 analyzes the detection value of the sensor input from the sensor group 104 at the timing when at least three legs are landed and a support polygon is formed while the robot apparatus 10 is traveling, and calculates each data (stop posture data) of (a) to (c) described above.

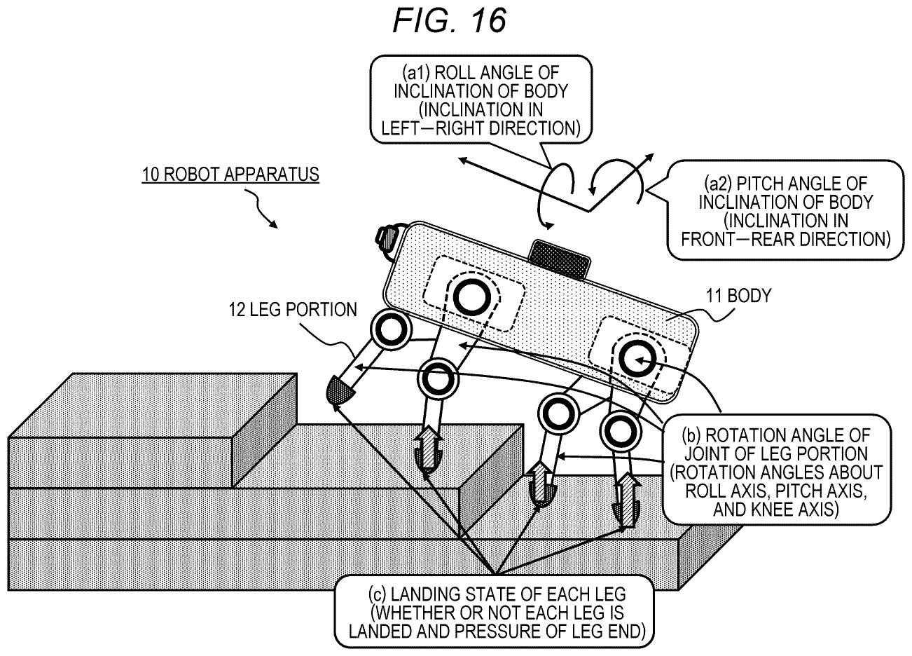

Specific examples of the stop posture data (a) to (c) will be described with reference to FIG. 16.

FIG. 16 illustrates the robot apparatus 10 that is traveling, that is, the robot apparatus 10 that is ascending staircase.

It is assumed that the stop posture analyzer 112 of the robot apparatus 10 determines that at least three legs are landed and the support polygon is formed at the timing illustrated in FIG. 16 while the robot apparatus 10 ascending the staircase. In this case, the stop posture analyzer 112 analyzes the stop posture at this timing.

As illustrated in FIG. 16, on the basis of the input value from the sensor group 104, the stop posture analyzer 112 acquires, as “stop posture” data, each of the following data:
(a) an inclination of the body (trunk) (inclination in each of the front-rear direction and the left-right direction);
(a1) a roll angle of the body (trunk) (=inclination of the body (trunk) in left-right direction);
(a2) a pitch angle of the body (trunk) (=inclination of the body (trunk) in the front-rear direction);
(b) rotation angle of joint of each leg (=rotation angles about roll axis, pitch axis, and knee axis of each leg); and
(c) whether or not each leg is landed and pressure of leg end.

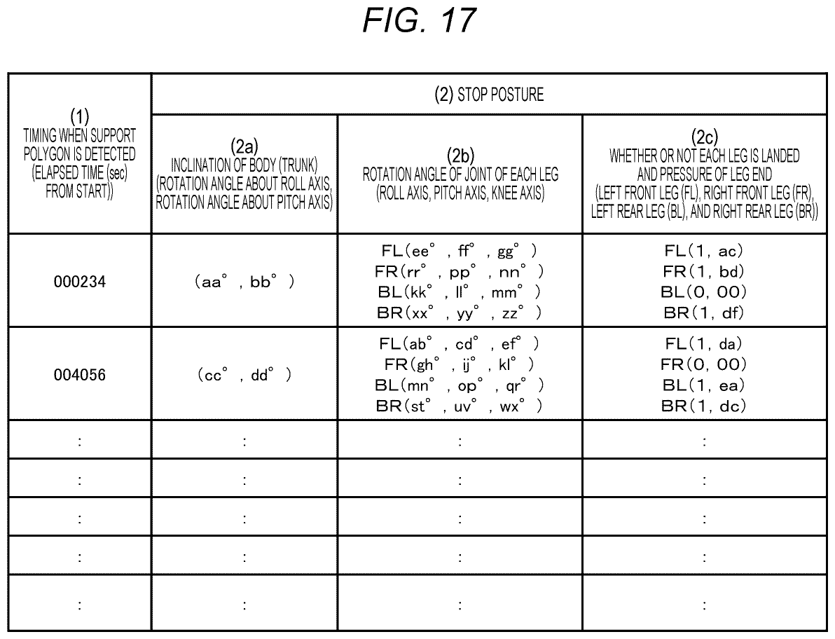

FIG. 17 is a diagram for describing an example of stop posture data analyzed by the stop posture analyzer 112.

The stop posture analyzer 112 generates stop posture data as illustrated in FIG. 17, that is, each of the following data:
(1) a support polygon detection timing;
(2) a stop posture;
(2a) the inclination of the body (trunk) (inclination in each of front-rear direction and left-right direction);
(2b) rotation angle of joint of each leg (=rotation angles about roll axis, pitch axis, and knee axis of each leg); and
(2c) whether or not each leg is landed and pressure of the leg end.
“(1) The support polygon detection timing” is time data indicating a timing at which the robot apparatus 10 lands at least three legs and a support polygon is formed. For example, the timing is an elapsed time (sec) from the start of traveling of the robot apparatus 10.

As described above, “(2a) the inclination of the body (trunk) (inclination in each of the front-rear direction and the left-right direction)” records the roll angle of the body (trunk) (=inclination of the body (trunk) in the left-right direction), and the pitch angle of the body (trunk) (=inclination of the body (trunk) in the front-back direction).

For example, the data (aa°, bb°) of the support polygon detection timing=000233 indicates
the roll angle of the body (trunk)=aa°, and
the pitch angle of the body (body)=bb°.
“(2b) The rotation angle of the joint of each leg (=the rotation angles about the roll axis, pitch axis, and knee axis of each leg)” records the rotation angle of the joint (=rotation angles about the roll axis, the pitch axis, and the knee axis of each leg) of each of the four legs.

FL represents the left front leg, FR represents the right front leg, BL represents the left rear leg, and BR represents the right rear leg. Three angle data in ( ) indicate rotation angle data about the roll axis, the pitch axis, and the knee axis of each leg.

In the “(2c) whether or not each leg is landed and the pressure of the leg end” records whether or not each of the four legs is landed and the pressure of each of the four legs.

FL is the left front leg, FR is the right front leg, BL is the left rear leg, and BR is the right rear leg, and the two data in ( ) includes the preceding data indicating whether or not landed (1=landed, 0=non landed) and the succeeding data indicating the leg end pressure at the time of landing.

In such a manner, in a case where the stop posture analyzer 112 of the robot apparatus 10 determines that at least three legs are landed while the robot apparatus 10 is traveling and the support polygon is formed, the stop posture analyzer analyzes the stop posture at this timing and sequentially generates stop posture data as illustrated in FIG. 17.

The stop posture data generated by the stop posture analyzer 112 is output to the stop posture evaluation value calculator 113.

The stop posture evaluation value calculator 113 inputs the stop posture data generated by the stop posture analyzer 112 and calculates an evaluation value of the stop posture.

The stop posture evaluation value calculator 113 performs calculation processing of the evaluation value (stop posture evaluation value) by applying a predefined evaluation value calculation algorithm on the basis of the stop posture data generated by the stop posture analyzer 112, that is, the stop posture data including each data of
(a) the inclination of the body (trunk) (inclination in each of the front-rear direction and the left-right direction),
(b) the rotation angle of the joint of each leg (=rotation angles about the roll axis, pitch axis, and knee axis of each leg), and
(c) whether or not each leg is landed and the pressure of the leg end.

As described above, the stop posture evaluation value calculator 113 calculates an evaluation value of the posture at the timing when at least three legs are landed and the support polygon is formed while the robot apparatus 10 is traveling, that is, the stop posture analyzed by the stop posture analyzer 112.

The stop posture evaluation value calculator 113 calculates an evaluation value by applying an evaluation value calculation algorithm defined in advance by using detection values of various sensors input from the sensor group 104 at the timing when the support polygon is formed.

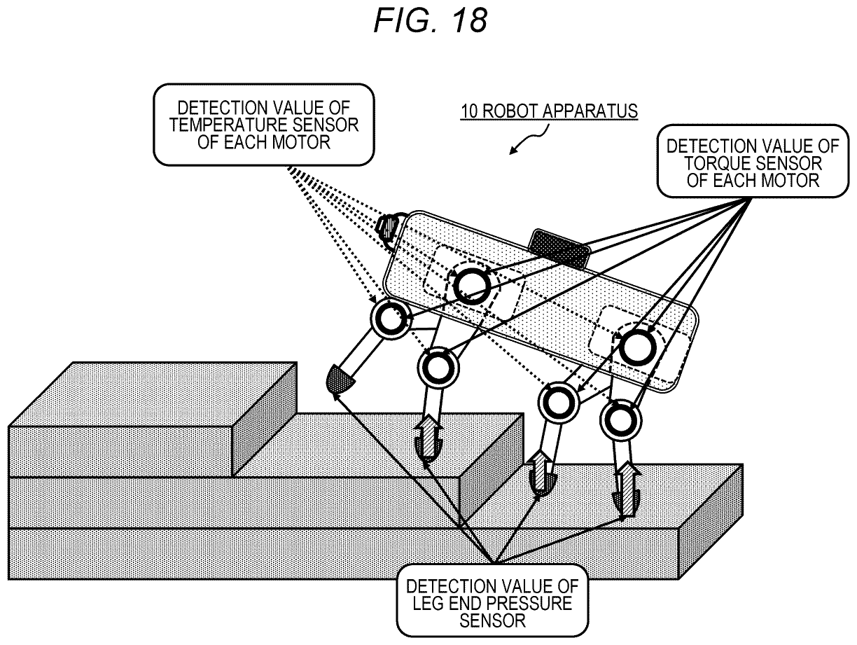

For example, as illustrated in FIG. 18, a detection value of the torque sensor of the motor of each leg of the robot apparatus 10, a detection value of the temperature sensor, a detection value of the leg end pressure sensor, and the like are input to calculate a stop posture evaluation value.

Note that the stop posture evaluation value calculated by the stop posture evaluation value calculator 111 is an evaluation value that is higher as the stability of the posture of the robot apparatus 10 is higher and is higher as a consumed energy calculated from the load of the motor and the like is lower.

As an algorithm for calculating the stop posture evaluation value by the stop posture evaluation value calculator 111, various algorithms are applicable.

For example, the following algorithms for calculating the stop posture evaluation value can be used:

(Example 1) an evaluation value calculation algorithm based on a total sum of torques which are detection values of torque sensors respectively belonging to the motors of the legs;

(Example 2) an evaluation value calculation algorithm based on a total sum of temperatures of the motors, which are detection values of the temperature sensors respectively belonging to the motors of the legs;

(Example 3) an evaluation value calculation algorithm based on a load balance of the leg calculated on the basis of the leg end pressure value which is a detection value of the leg end pressure sensor of each leg.

(Example 4) an evaluation value calculation algorithm based on a rotation angle of the motor of each leg and a load balance of the leg calculated on the basis of the leg end pressure value which is a detection value of the leg end pressure sensor of each leg.

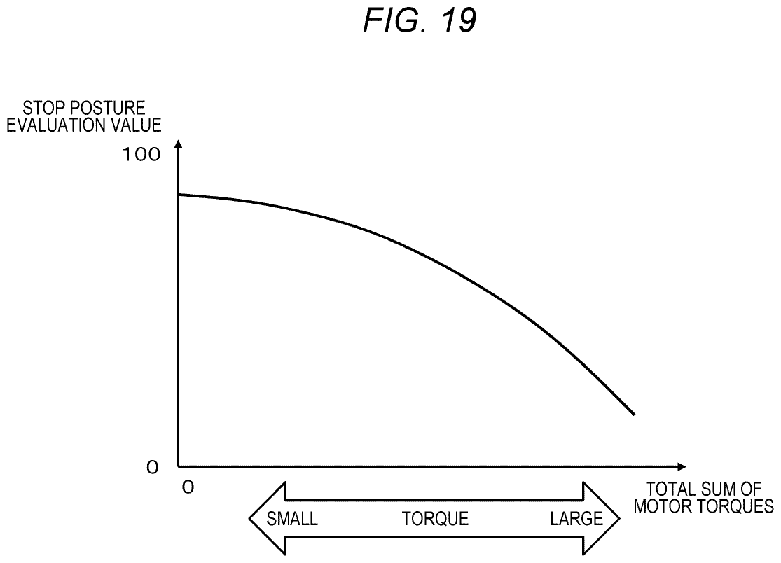

FIG. 19 is a diagram for describing an example of stop posture evaluation value calculation according to (Example 1) described above, that is,

(Example 1) the evaluation value calculation algorithm based on the total sum of torques which are detection values of the torque sensors respectively belonging to the motors of the legs.

The graph illustrated in FIG. 19 is a graph in which the horizontal axis represents the total sum of motor torques and the vertical axis represents the stop posture evaluation value (0 to 100).

The stop posture evaluation value increases as the total sum of the motor torques decreases, and the stop posture evaluation value decreases as the total sum of the motor torques increases.

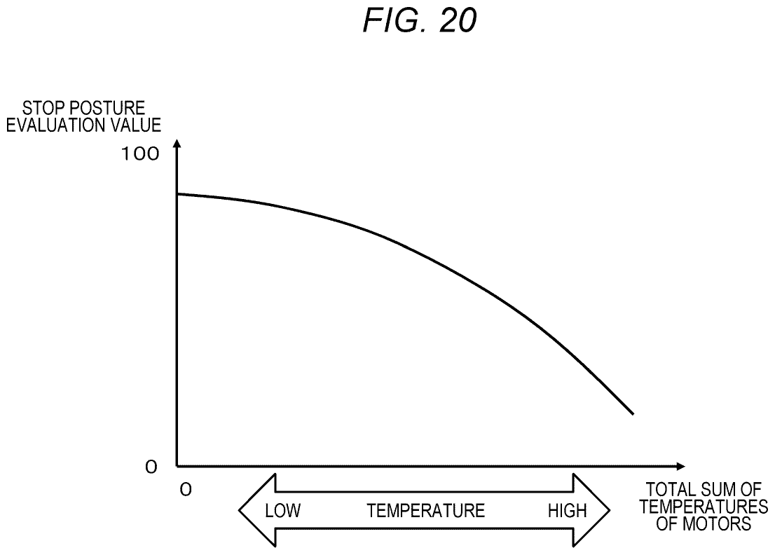

FIG. 20 is a diagram for describing an example of stop posture evaluation value calculation according to (Example 2) described above, that is,

(Example 2) the evaluation value calculation algorithm based on the total sum of temperatures of the motors, which are detection values of the temperature sensors respectively belonging to the motors of the legs.

The graph illustrated in FIG. 20 is a graph in which the horizontal axis represents the total sum of temperatures of the motors and the vertical axis represents the stop posture evaluation value (0 to 100).

The stop posture evaluation value increases as the total sum of motor torques decreases, and the stop posture evaluation value decreases as the total sum of motor torques increases.

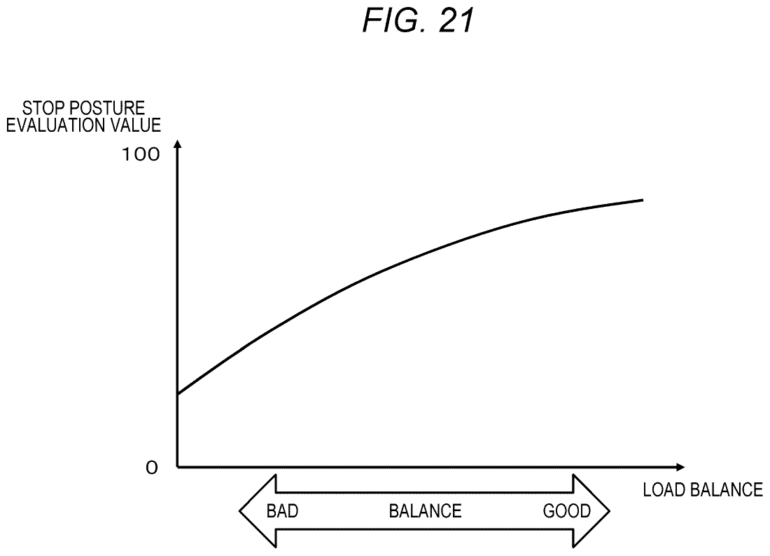

FIG. 21 is a diagram for describing an example of stop posture evaluation value calculation according to (Example 3) and (Example 4) described above, that is,

(Example 3) the evaluation value calculation algorithm based on the load balance of the leg calculated on the basis of the leg end pressure value which is the detection value of the leg end pressure sensor of each leg, and

(Example 4) the evaluation value calculation algorithm based on the rotation angle of the motor of each leg and the load balance of the leg calculated on the basis of the leg end pressure value which is the detection value of the leg end pressure sensor of each leg.

The graph illustrated in FIG. 21 is a graph in which the horizontal axis represents the load balance and the vertical axis represents the stop posture evaluation value (0 to 100).

The stop posture evaluation value decreases as the load balance is worse, and the stop posture evaluation value increases as the load balance is better (for example, the load is applied equally to each leg).

Note that, as the algorithm for calculating the stop posture evaluation value by the stop posture evaluation value calculator 111, various algorithms as described above in (Example 1) to (Example 4) are applicable.

Furthermore, a final stop posture evaluation value may be calculated by weighted addition of the evaluation values respectively calculated by the algorithms of (Example 1) to (Example 4) described above.

For example, in a case where the evaluation values calculated by respectively applying the algorithms of (Example 1) to (Example 4) described above are V1 to V4, respectively, a final stop posture evaluation value Vall is calculated in accordance with the following (Equation 1).

Vall=α·V1+β·V2+γ·V3+δ·V4 (Equation 1)

Note that α, β, γ, and δ are weighting coefficients.

In such a manner, the stop posture evaluation value calculator 113 calculates an evaluation value of the posture at the timing when at least three legs are landed and the support polygon is formed while the robot apparatus 10 is traveling, that is, the stop posture analyzed by the stop posture analyzer 112.

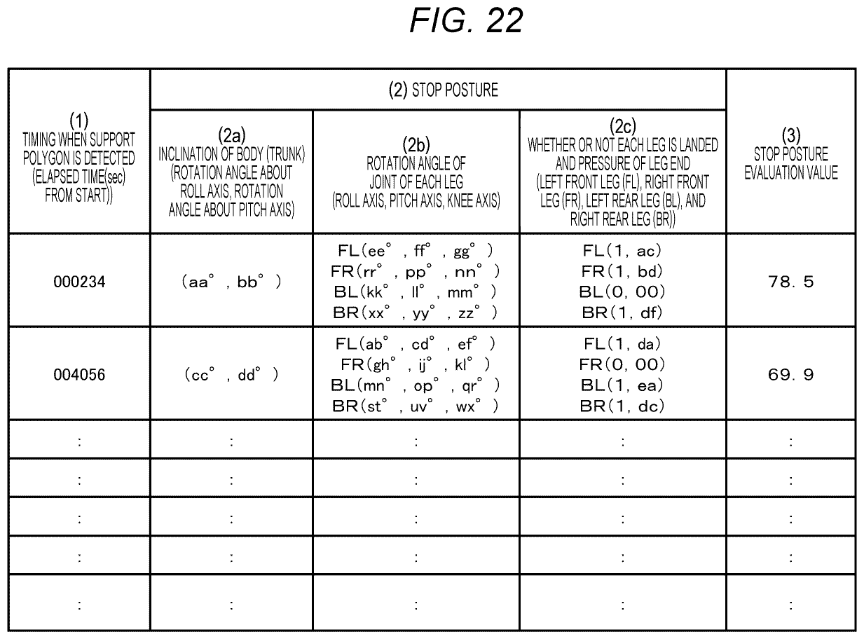

FIG. 22 illustrates an example of the evaluation value calculated by the stop posture evaluation value calculator 113.

FIG. 22 illustrates the stop posture data analyzed by the stop posture analyzer 112 described above with reference to FIG. 17 and the stop posture evaluation value calculated by the stop posture evaluation value calculator 113 in association with each other.

That is, the data is data corresponding to the data of
(1) the support polygon detection timing,
(2) the stop posture, and
(3) the stop posture evaluation value.
“(2) The stop posture” is the data described above with reference to FIGS. 16 and 17, is the robot posture when the robot apparatus 10 forms the support polygon configured by landing at least three legs, and is the data analyzed by the stop posture analyzer 112.

That is, each of the following data is included:
(a) an inclination of the body (trunk) (inclination in each of the front-rear direction and the left-right direction);
(a1) a roll angle of the body (trunk) (=inclination of the body (trunk) in left-right direction);
(a2) a pitch angle of the body (trunk) (=inclination of the body (trunk) in the front-rear direction);
(b) rotation angle of joint of each leg (=rotation angles about roll axis, pitch axis, and knee axis of each leg); and
(c) whether or not each leg is landed and pressure of leg end.
“(3) The stop posture evaluation value” is an evaluation value corresponding to “(2) the stop posture”. That is, the evaluation value is an evaluation value calculated by the stop posture evaluation value calculator 113 for the “stop posture” which is the robot posture when the robot apparatus 10 forms the support polygon configured by landing at least three legs.

In such a manner, the stop posture evaluation value calculator 113 calculates an evaluation value (stop posture evaluation value) corresponding to the “stop posture” at the timing when the stop posture analyzer 112 determines that at least three legs are landed and a support polygon is formed while the robot apparatus 10 is traveling.

As described above, the stop posture analyzer 112 and the stop posture evaluation value calculator 113 analyze the stop posture at the timing when at least three legs are landed and a support polygon is formed while the robot apparatus 10 is traveling, and calculate the evaluation value of the stop posture. Note that the above processing is executed at the first timing when the formation of a support polygon is confirmed after a change in the shape of the traveling surface is detected during traveling of the robot apparatus 10.

Note that a specific sequence of the processing will be described later with reference to flowcharts.

The stop posture information and the evaluation value (stop posture evaluation value) generated and calculated by the stop posture analyzer 112 and the stop posture evaluation value calculator 113 are output to the suitable stop posture record updater 114.

Next, processing executed by the suitable stop posture record updater 114 will be described.

The suitable stop posture record updater 114 inputs each of the following data:
(1) traveling surface shape clustering data (C11 and the like) analyzed by the traveling surface shape analyzer 111; and
(2) the stop posture generated by stop posture analyzer 112 and the stop posture evaluation value calculator 113, and an evaluation value of the stop posture (stop posture evaluation value).

“(2) The stop posture generated by the stop posture analyzer 112 and the stop posture evaluation value calculator 113 and the evaluation value of the stop posture (stop posture evaluation value)” described above are respectively the stop posture and the stop posture evaluation value at the timing when the support polygon is formed while the robot apparatus 10 is traveling.

By using these input data, the suitable stop posture record updater 114 executes processing of recording a “suitable stop posture and evaluation value data corresponding to a traveling surface shape clustering group” in the storage 105 and processing of updating the recorded data.

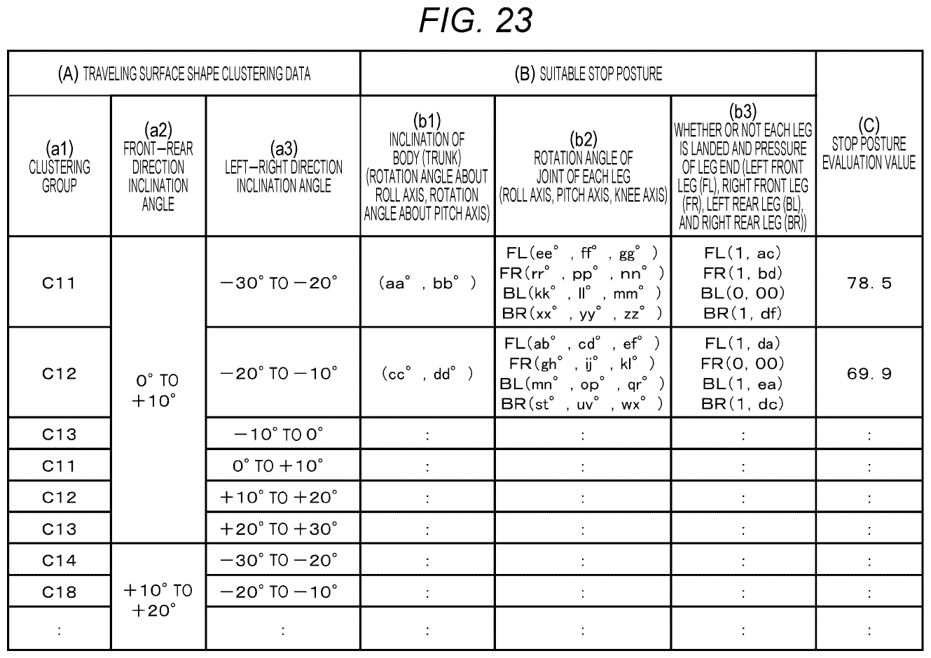

A data configuration example of the “suitable stop posture and evaluation value data corresponding to the traveling surface shape clustering group” recorded in the storage 105 will be described with reference to FIG. 23.

As illustrated in FIG. 23, the “suitable stop posture and evaluation value data corresponding to the traveling surface shape clustering group” includes each of the following data:
(A) the traveling surface shape clustering data;
(B) the suitable stop posture; and
(C) the stop posture evaluation value.
The “(B) suitable stop posture” and the “(C) stop posture evaluation value” are the stop posture and the stop posture evaluation value at the timing when a support polygon is formed while the robot apparatus 10 is traveling, and are data generated by the stop posture analyzer 112 and the stop posture evaluation value calculator 113 as described above.
“(A) The traveling surface shape clustering data” is traveling surface shape clustering data analyzed by the traveling surface shape analyzer 111, and includes each of the following data:
(a1) the clustering group;
(a2) the front-rear direction inclination angle; and
(a3) the left-right direction inclination angle.

The above data are recorded by extracting data of generation timings of “(B) the suitable stop posture” and “(C) the stop posture evaluation value” from the data described above with reference to FIG. 15.

That is, the “(B) the suitable stop posture” and the “(C) the stop posture evaluation value” are the stop posture and the stop posture evaluation value at the timing when a support polygon is formed while the robot apparatus 10 is traveling, and “(A) the traveling surface shape clustering data” at the same timing is recorded in association. The data is extracted at the same timing by collating (A) the time data of the data illustrated in FIG. 15 with the time data of (1) the support polygon detection timing of the data illustrated in FIG. 22.

The suitable stop posture record updater 114 sequentially records, in the storage 105, the stop posture of the highest evaluation value corresponding to a plurality of different shapes of the traveling surface as “(B) the suitable stop posture” with “(C) the stop posture evaluation value” which is the evaluation value of the stop posture in association with “(A) the traveling surface shape clustering data”.

In a case where a support polygon is detected on a traveling surface having a new shape of a traveling surface on which data is not yet recorded and the “stop posture” and the “stop posture evaluation value” are calculated while the robot apparatus 10 is traveling, an entry in association with the following data:
(A) the traveling surface shape clustering data,
(B) the suitable stop posture, and
(C) the stop posture evaluation value
is added to the “suitable stop posture and evaluation value data corresponding to the traveling surface shape clustering group” as new data and stored in the storage 105.

The suitable stop posture record updater 114 further compares the “stop posture evaluation value” of the data already stored in the storage 105 with the newly calculated “stop posture evaluation value” in a case where the support polygon is detected on the traveling surface having the same shape as the shape of the traveling surface already recorded as the “suitable stop posture and evaluation value data corresponding to the traveling surface shape clustering group” while the robot apparatus 10 is traveling and the “stop posture” and the “stop posture evaluation value” are calculated.

As a result of the comparison processing, in a case where the newly calculated “stop posture evaluation value” is an evaluation value higher than the “stop posture evaluation value” of the data already stored in the storage 105, data update processing of replacing the “suitable stop posture” and the “stop posture evaluation value” already stored in the storage 105 with the data having a higher evaluation is executed.

By performing such data update processing, the “suitable stop posture and evaluation value data corresponding to the traveling surface shape clustering group” having the data configuration illustrated in FIG. 23 stored in the storage 105 is sequentially rewritten to the “suitable stop posture” having a higher evaluation value corresponding to each shape of the travel surface.

When executing stop processing of the robot apparatus 10 illustrated in FIG. 12, the stop control unit 120 of the robot apparatus 10 refers to the data illustrated in FIG. 23, that is, the “suitable stop posture and evaluation value data corresponding to the traveling surface shape clustering group” stored in the storage 105, and controls the stop posture to stop.

That is, an entry having “(A) the traveling surface shape clustering data” matching the shape of the traveling surface at the time of execution of the stop processing is selected, “(B) the suitable stop posture” recorded in the selected entry is acquired, the posture control of the robot apparatus is performed so as to have a posture matching the acquired “(B) suitable stop posture”, and the robot apparatus 10 is stopped.

By performing such stop posture control, it is possible to perform stop processing with higher stability.

Processing executed by the stop control unit 120 of the robot apparatus 10 illustrated in FIG. 12 will be described.

The stop control unit 120 of the robot apparatus 10 starts processing for performing stop processing with reception of a stop command as a trigger via the communication unit 101, for example.

As illustrated in FIG. 12, the stop control unit 120 of the robot apparatus 10 includes the suitable stop posture acquirer 121 and the stop posture control unit 122.

The suitable stop posture acquirer 121 receives input of current traveling surface shape data (traveling surface shape clustering data) during traveling of the robot apparatus 10 from the traveling surface shape analyzer 111.

The traveling surface shape data (traveling surface shape clustering data) input from the traveling surface shape analyzer 111 is the data described above with reference to FIG. 15.

That is, the data is each of the following data illustrated in FIG. 15:
(b1) the clustering group;
(b2) the front-rear direction inclination angle; and
(b3) the left-right direction inclination angle.

Note that the traveling surface shape data (traveling surface shape clustering data) input from the traveling surface shape analyzer 111 by the suitable stop posture acquirer 121 is the traveling surface shape data (traveling surface shape clustering data) at the present time, that is, at the time when the stop command is input.

The suitable stop posture acquirer 121 acquires a clustering group (Cnn) in the traveling surface shape data (traveling surface shape clustering data) input from the traveling surface shape analyzer 111.

Furthermore, entry data of the same clustering group (Cnn) as the acquired clustering group (Cnn) is acquired from the “suitable stop posture and evaluation value data corresponding to the traveling surface shape clustering group” in the storage 105.

That is, the entry of the clustering group (Cnn) corresponding to the shape of the current traveling surface is selected from the “suitable stop posture and evaluation value data corresponding to the traveling surface shape clustering group” described above with reference to FIG. 23, and data of the “suitable stop posture” of the selected entry is acquired.

The “suitable stop posture” is a stop posture recorded in the storage 105 as data having the highest “stop posture evaluation value” in travel processing of the robot apparatus 10 so far.

The suitable stop posture acquirer 121 acquires, from the storage 105, the “suitable stop posture” having the highest evaluation, which is data stored in the storage and corresponding to the shape of the current traveling surface of the robot apparatus 10, and outputs the posture information to the stop posture control unit 122.

The stop posture control unit 122 performs posture control by driving the drive unit 103 of the robot apparatus 10 so as to have a posture matching the “suitable stop posture” input from the suitable stop posture acquirer 121, and stops the robot apparatus 10 in a state where the posture matches the “suitable stop posture”.

By performing such stop posture control, it is possible to perform stop processing with higher stability.

### 4. Sequence of Processing Executed by Robot Apparatus of Present Disclosure

Next, a sequence of the processing executed by the robot apparatus 10 of the present disclosure will be described.

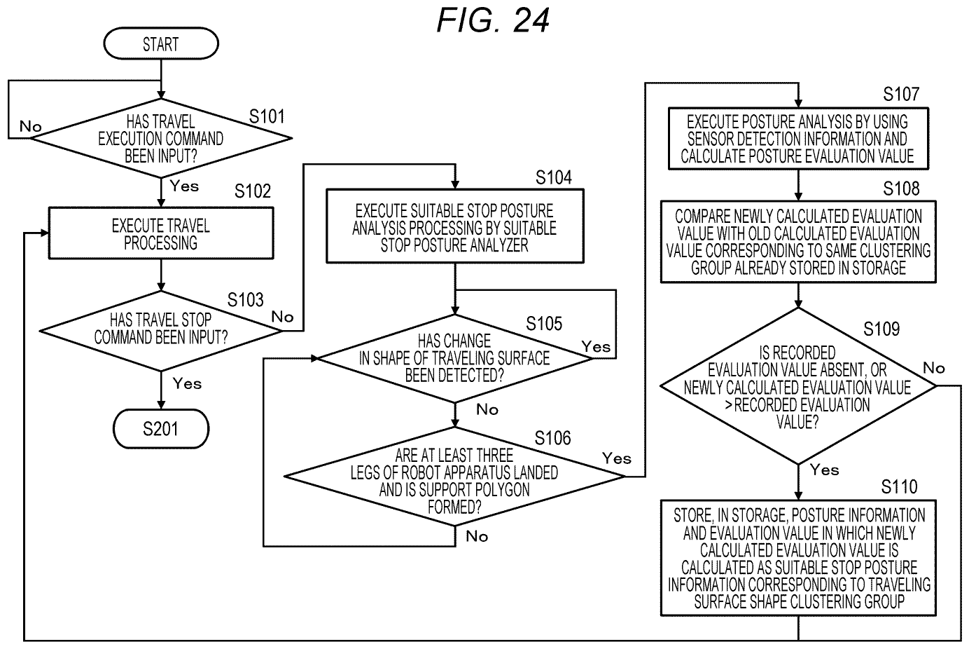

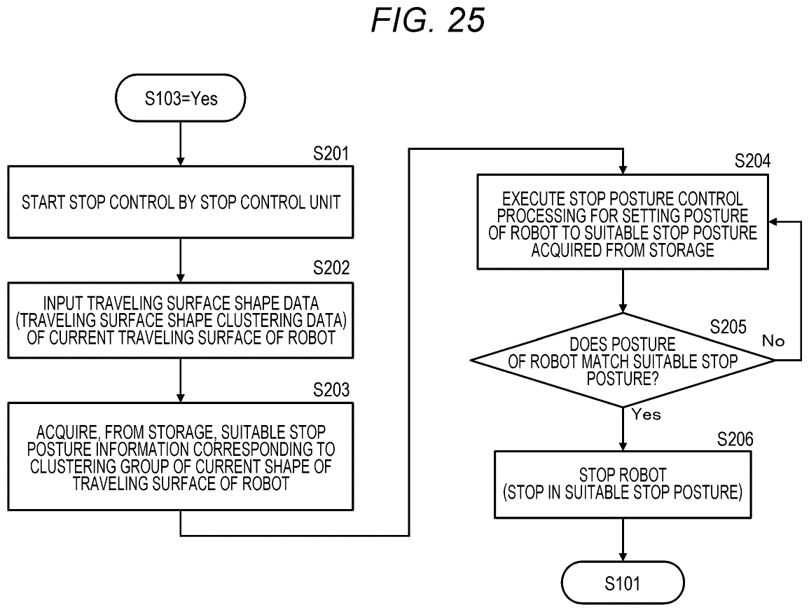

FIGS. 24 and 25 are diagrams illustrating flowcharts for describing a sequence of the processing executed by the robot apparatus 10 of the present disclosure.

The flowchart shown in FIG. 24 is a flowchart for mainly describing a processing sequence executed by the suitable stop posture analyzer 110 of the robot apparatus 10 illustrated in FIG. 12.

The flowchart shown in FIG. 25 is a flowchart for mainly describing a processing sequence executed by the stop control unit 120 of the robot apparatus 10 illustrated in FIG. 12.

Note that these flowcharts can be implemented under the control of a data processor having a program execution function, such as a CPU, in accordance with a program stored in the storage in the robot apparatus 10.

First, the processing sequence executed by the suitable stop posture analyzer 110 of the robot apparatus 10 illustrated in FIG. 12 will be described with reference to the flowchart illustrated in FIG. 24.

Hereinafter, details of processing of each step of the flow illustrated in FIG. 24 will be sequentially described.

### (Step S101)

First, the robot apparatus 10 determines whether or not a travel execution command is input.

This determination processing is executed, for example, by the travel control unit 102 of the robot apparatus 10 illustrated in FIG. 12. The travel control unit 102 determines, for example, whether or not a travel execution command has been input from the user terminal 60 operated by the user 50 via the communication unit 101.

In a case where input of the travel execution command has been detected, a determination in step S101 is Yes, and the processing proceeds to step S102.

### (Step S102)

In a case where it is determined in step S101 that the input of the travel execution command is detected, the travel processing of the robot apparatus 10 is started in step S102.

The travel processing of the robot apparatus 10 is executed under the control of the travel control unit 102.

### (Step S103)

The robot apparatus 10 starts traveling in step S102, and then, the robot apparatus 10 determines whether or not a travel stop command has been input in step S103.

The travel control unit 102 determines, for example, whether or not a travel stop command has been input from the user terminal 60 operated by the user 50 via the communication unit 101.

In a case where the input of the travel stop command has been detected, the determination in step S103 is Yes, and the processing proceeds to step S201.

On the other hand, in a case where the input of the travel stop command has not been detected, the determination in step S103 is No, and the processing proceeds to step S104.

### (Step S104)

In a case where it is determined in step S103 that the input of the travel stop command is not detected, the robot apparatus 10 executes the processing of step S104 and subsequent steps.

In this case, in step S104, suitable stop posture analysis processing by the suitable stop posture analyzer 110 is started.

The processing of steps S104 to S110 is processing executed by the suitable stop posture analyzer 110, and is processing executed while the robot apparatus 10 is traveling.

### (Step S105)

First, in step S105, the suitable stop posture analyzer 110 detects the presence or absence of a change in the shape of the traveling surface of the robot apparatus 10.

This processing is executed by the traveling surface shape analyzer 111 of the suitable stop posture analyzer 110 of the robot apparatus 10 illustrated in FIG. 12.

The traveling surface shape analyzer 111 inputs and analyzes detection information of various sensors of the sensor group 104, and detects the presence or absence of a change in the shape of the traveling surface of the robot apparatus 10.

In a case where a change in the shape of the traveling surface has been detected, the determination in step S105 is Yes, and the processing proceeds to step S106.

### (Step S106)

Next, in step S106, the suitable stop posture analyzer 110 determines whether or not at least three legs of the robot apparatus 10 are landed and a support polygon is formed.

This process is processing executed by the stop posture analyzer 112 of the suitable stop posture analyzer 110.

As described above, the stop posture analyzer 112 analyzes the posture of the robot apparatus 10 at the time of stopping, and the acquires stop posture information.

In a case where it is determined in step S106 that at least three legs of the robot apparatus 10 are landed and a support polygon is formed, the processing proceeds to step S107.

In a case where at least three legs of the robot apparatus 10 are landed and a support polygon is not formed, the determination processing in steps S105 to S106 is continued.

### (Step S107)

In a case where the stop posture analyzer 112 of the suitable stop posture analyzer 110 determines that at least three legs of the robot apparatus 10 are landed and a support polygon is formed in step S106, the processing of step S107 is executed.

In this case, in step S107, the posture (stop posture) of the robot apparatus 10 at the time of forming the support polygon is analyzed by using the sensor detection information, and the evaluation value (stop posture evaluation value) of the stop posture is calculated.

This processing is executed by the stop posture analyzer 112 and the stop posture evaluation value calculator 113 of the suitable stop posture analyzer 110.

The stop posture analyzer 112 determines whether or not at least three legs are landed and a support polygon is formed while the robot apparatus 10 is traveling. In a case where determining that the support polygon is formed, the stop posture analyzer 112 analyzes the posture at a timing when the support polygon is formed as the “stop posture”.

This processing is executed without stopping the robot apparatus 10.

When at least three legs are landed and the support polygon is formed, the robot apparatus 10 can be stopped. Thus, the stop posture analyzer 112 analyzes the posture at this timing as the “stop posture” without actually stopping the robot apparatus 10.

The stop posture analyzer 112 acquires detection values of various sensors input from the sensor group 104 at the timing when the support polygon is formed, and analyzes the posture at that timing as the “stop posture”.

Furthermore, the stop posture evaluation value calculator 113 calculates an evaluation value (stop posture evaluation value) by applying a predefined evaluation value calculation algorithm to the “stop posture”.

The stop posture analyzer 112 and the stop posture evaluation value calculator 113 analyze the “stop posture” on the basis of, for example, the inclination of the robot which is a detection value of the IMU, the load of the motor analyzed from the detection values of the temperature sensor and the torque sensor belonging to each motor, the landing and the weight amount of each leg detected from the pressure sensor of each leg end, and the like, and calculate the “stop posture evaluation value”.

As described above with reference to FIGS. 16 and 17, the “stop posture” analyzed by the stop posture analyzer 112 includes, for example, each of the following data:
(a) inclination of body (trunk) (inclination in each of front-rear direction and left-right direction);
(b) rotation angle of joint of each leg (=rotation angles about roll axis, pitch axis, and knee axis of each leg); and
(c) whether or not each leg is landed and pressure of leg end.

The stop posture analyzer 112 generates “stop posture” data including the above data (a) to (c) on the basis of the input value from the sensor group 104.

In such a manner, in a case where the stop posture analyzer 112 of the robot apparatus 10 determines that at least three legs are landed while the robot apparatus 10 is traveling and the support polygon is formed, the stop posture analyzer analyzes the stop posture at this timing, and analyzes the stop posture.

The stop posture data generated by the stop posture analyzer 112 is output to the stop posture evaluation value calculator 113.

The stop posture evaluation value calculator 113 inputs the stop posture data generated by the stop posture analyzer 112 and calculates an evaluation value of the stop posture.

The stop posture evaluation value calculator 113 performs calculation processing of the evaluation value (stop posture evaluation value) by applying a predefined evaluation value calculation algorithm on the basis of the stop posture data generated by the stop posture analyzer 112, that is, the stop posture data including each data of
(a) the inclination of the body (trunk) (inclination in each of the front-rear direction and the left-right direction),
(b) the rotation angle of the joint of each leg (=rotation angles about the roll axis, pitch axis, and knee axis of each leg), and
(c) whether or not each leg is landed and the pressure of the leg end.

The stop posture evaluation value calculator 113 calculates an evaluation value by applying an evaluation value calculation algorithm defined in advance by using detection values of various sensors input from the sensor group 104 at the timing when the support polygon is formed.

For example, as described above with reference to FIG. 18, a detection value of the torque sensor of the motor of each leg of the robot apparatus 10, a detection value of the temperature sensor, a detection value of the leg end pressure sensor, and the like are input to calculate a stop posture evaluation value.

Note that the stop posture evaluation value calculated by the stop posture evaluation value calculator 111 is an evaluation value that is higher as the stability of the posture of the robot apparatus 10 is higher and is higher as a consumed energy calculated from the load of the motor and the like is lower.

As described above with reference to FIGS. 19 to 22, as an algorithm for calculating the stop posture evaluation value by the stop posture evaluation value calculator 111, for example, the following algorithms can be used:

(Example 1) an evaluation value calculation algorithm based on a total sum of torques which are detection values of torque sensors respectively belonging to the motors of the legs;

(Example 2) an evaluation value calculation algorithm based on a total sum of temperatures of the motors, which are detection values of the temperature sensors respectively belonging to the motors of the legs;

(Example 3) an evaluation value calculation algorithm based on a load balance of the leg calculated on the basis of the leg end pressure value which is a detection value of the leg end pressure sensor of each leg.

(Example 4) an evaluation value calculation algorithm based on a rotation angle of the motor of each leg and a load balance of the leg calculated on the basis of the leg end pressure value which is a detection value of the leg end pressure sensor of each leg.

In addition, for example, the evaluation values calculated by respectively applying the algorithms of (Example 1) to (Example 4) described above may be set as V1 to V4, respectively, and a final stop posture evaluation value Vall may be calculated in accordance with the following (Equation 1).

Vall=α·V1+β·V2+γ·V3+δ·V4 (Equation 1)

Note that α, β, γ, and δ are weighting coefficients.

In such a manner, the stop posture evaluation value calculator 113 calculates an evaluation value of the posture at the timing when at least three legs are landed and the support polygon is formed while the robot apparatus 10 is traveling, that is, the stop posture analyzed by the stop posture analyzer 112.

In such a manner, in step S107, the stop posture analyzer 112 and the stop posture evaluation value calculator 113 analyze the stop posture at the timing when at least three legs are landed and a support polygon is formed while the robot apparatus 10 is traveling, and calculate the evaluation value of the stop posture.

The stop posture information and the evaluation value (stop posture evaluation value) generated and calculated by the stop posture analyzer 112 and the stop posture evaluation value calculator 113 are output to the suitable stop posture record updater 114.

### (Step S108)

In the next step S108, processing of comparing a newly calculated evaluation value (newly calculated stop posture evaluation value) calculated by the stop posture evaluation value calculator 113 in step S107 with an existing evaluation value already calculated and already stored in the storage 105 is executed.

This processing is processing executed by the suitable stop posture record updater 114.

As described above, the suitable stop posture record updater 114 inputs each of the following data:
(1) traveling surface shape clustering data (C11 and the like) analyzed by the traveling surface shape analyzer 111; and
(2) the stop posture generated by stop posture analyzer 112 and the stop posture evaluation value calculator 113, and an evaluation value of the stop posture (stop posture evaluation value).
“(2) The stop posture generated by the stop posture analyzer 112 and the stop posture evaluation value calculator 113 and the evaluation value of the stop posture (stop posture evaluation value)” described above are respectively the stop posture and the stop posture evaluation value at the timing when the support polygon is formed while the robot apparatus 10 is traveling.

By using these input data, the suitable stop posture record updater 114 executes processing of recording a “suitable stop posture and evaluation value data corresponding to a traveling surface shape clustering group” in the storage 105 and processing of updating the recorded data.

The processing of recording the “suitable stop posture and evaluation value data corresponding to the traveling surface shape clustering group” described above with reference to FIG. 23 and the processing of updating the recorded data.

In step S108, the suitable stop posture record updater 114 compares the “stop posture evaluation value” calculated in step S107 with the “stop posture evaluation value” of the data already stored in the storage 105.

The suitable stop posture record updater 114 selects an entry matching a traveling surface shape clustering group at a calculation timing of the newly calculated evaluation value (newly calculated stop posture evaluation value) of the stop posture evaluation value calculator 113 in step S107 from the “suitable stop posture and evaluation value data corresponding to the traveling surface shape clustering group” already stored in the storage 105, and compares the evaluation value of the selected entry with the value of the newly calculated evaluation value.

### (Step S109)

Next, the suitable stop posture record updater 114 executes the following determination processing in step S109.

That is, it is determined whether or not there is recorded data in the storage 105 that matches the traveling surface shape clustering group at the calculation timing of the newly calculated evaluation value (newly calculated stop posture evaluation value) of the stop posture evaluation value calculator 113 in step S107.

Furthermore, in a case where there is recorded data that matches the traveling surface shape clustering group, it is determined whether or not the newly calculated evaluation value is a value larger than the stop posture evaluation value of the recorded data in the storage 105.

In a case where recorded data that matches the traveling surface shape clustering group is not recorded in the storage 105 or the newly calculated evaluation value is a value larger than the stop posture evaluation value of the record data in the storage 105, the determination in step S109 is Yes, and the processing proceeds to step S110.

On the other hand, in a case where recorded data that matches the traveling surface shape clustering group is recorded in the storage 105 or the newly calculated evaluation value is not a value larger than the stop posture evaluation value of the record data in the storage 105, the determination in step S109 is No, and the processing returns to step S102.

### (Step S110)

In a case where the determination in step S109 is Yes, that is, in a case where it is determined that recorded data that matches the traveling surface shape clustering group at the calculation timing of the newly calculated evaluation value (newly calculated stop posture evaluation value) of the stop posture evaluation value calculator 113 in step S107 is not recorded in the storage 105, or in a case where the newly calculated evaluation value is a value larger than the stop posture evaluation value of the recorded data in the storage 105, the processing in step S110 is executed.

In this case, the suitable stop posture record updater 114 executes record and update processing of the recorded data in the storage 105 in step S110.

In a case where it is determined that recorded data that matches the traveling surface shape clustering group at the calculation timing of the newly calculated evaluation value (newly calculated stop posture evaluation value) of the stop posture evaluation value calculator 113 in step S107 is not recorded in the storage 105, an entry in association with the following data:
(A) the traveling surface shape clustering data,
(B) the suitable stop posture, and
(C) the stop posture evaluation value
is added to the “suitable stop posture and evaluation value data corresponding to the traveling surface shape clustering group” as new data and stored in the storage 105.

In addition, in a case where it is determined that recorded data that matches the traveling surface shape clustering group at the calculation timing of the newly calculated evaluation value (newly calculated stop posture evaluation value) of the stop posture evaluation value calculator 113 in step S107 is recorded in the storage 105, but the newly calculated evaluation value is a value larger than the stop posture evaluation value of the recorded data in the storage 105, the following processing is executed.

Data update processing of replacing the “suitable stop posture” and the “stop posture evaluation value” already stored in the storage 105 with the “stop posture” and the “stop posture evaluation value” calculated in step S107 is executed.

By performing such data update processing, data stored in the storage 105, that is, the “suitable stop posture and evaluation value data corresponding to the traveling surface shape clustering group” having the data configuration illustrated in FIG. 23 is sequentially rewritten to the “suitable stop posture” having a higher evaluation value corresponding to each shape of the travel surface.

When executing stop processing of the robot apparatus 10 illustrated in FIG. 12, the stop control unit 120 of the robot apparatus 10 refers to the data illustrated in FIG. 23, that is, the “suitable stop posture and evaluation value data corresponding to the traveling surface shape clustering group” stored in the storage 105, and controls the stop posture to stop.

That is, an entry having “(A) the traveling surface shape clustering data” matching the shape of the traveling surface at the time of execution of the stop processing is selected, “(B) the suitable stop posture” recorded in the selected entry is acquired, the posture control of the robot apparatus is performed so as to have a posture matching the acquired “(B) suitable stop posture”, and the robot apparatus 10 is stopped.

By performing such stop posture control, it is possible to perform stop processing with higher stability.

After the data update processing in step S110 of the flowchart illustrated in FIG. 24 is completed, the processing returns to step S102 to continue the travel processing, and calculation of a suitable stop posture corresponding to a new different shape of the traveling surface and evaluation value calculation processing, and record and update processing of these data in the storage 105 are executed.

Next, a processing sequence executed by the stop control unit 120 of the robot apparatus 10 illustrated in FIG. 12 will be described with reference to the flowchart illustrated in FIG. 25.

The flow illustrated in FIG. 25 is executed in a case where the determination is Yes in step S103 of the flowchart illustrated in FIG. 24.

For example, in a case where it is determined in step S103 of the flowchart illustrated in FIG. 24 that a travel stop command is input from the user terminal 60 operated by the user 50 via the communication unit 101, the stop control unit 120 of the robot apparatus 10 illustrated in FIG. 12 executes the processing in step S201 and the subsequent steps illustrated in FIG. 25.

Hereinafter, details of processing of each step of the flow illustrated in FIG. 25 will be sequentially described.

### (Step S201)

In a case where it is determined in step S103 that a travel stop command is input from the user terminal 60 operated by the user 50 via the communication unit 101, for example, in the robot apparatus 10, the stop control unit 120 of the robot apparatus 10 illustrated in FIG. 12 starts the stop control processing in step S201.

### (Step S202)

In step S202, the stop control unit 120 of the robot apparatus 10 inputs the traveling surface shape data (traveling surface shape clustering data) of the current traveling surface of the robot apparatus 10.

This processing is processing executed by the suitable stop posture acquirer 121 of the stop control unit 120 of the robot apparatus 10 illustrated in FIG. 12.

The suitable stop posture acquirer 121 receives input of current traveling surface shape data (traveling surface shape clustering data) during traveling of the robot apparatus 10 from the traveling surface shape analyzer 111.

The traveling surface shape data (traveling surface shape clustering data) input from the traveling surface shape analyzer 111 is the data described above with reference to FIG. 15.

That is, the data is each of the following data illustrated in FIG. 15:
(b1) the clustering group;
(b2) the front-rear direction inclination angle; and
(b3) the left-right direction inclination angle.

Note that the traveling surface shape data (traveling surface shape clustering data) input from the traveling surface shape analyzer 111 by the suitable stop posture acquirer 121 is the traveling surface shape data (traveling surface shape clustering data) at the present time, that is, at the time when the stop command is input.

The suitable stop posture acquirer 121 acquires a clustering group (Cnn) in the traveling surface shape data (traveling surface shape clustering data) input from the traveling surface shape analyzer 111.

### (Step S203)

Next, in step S203, from the “suitable stop posture and evaluation value data corresponding to the traveling surface shape clustering group” in the storage 105, the suitable stop posture acquirer 121 acquires entry data of the same clustering group (Cnn) as the clustering group (Cnn) indicating the shape of the traveling surface on which the robot apparatus 10 is currently traveling, the clustering group (Cnn) being acquired from the traveling surface shape analyzer 111.

That is, the entry of the clustering group (Cnn) corresponding to the shape of the current traveling surface is selected from the “suitable stop posture and evaluation value data corresponding to the traveling surface shape clustering group” described above with reference to FIG. 23, and data of the “suitable stop posture” of the selected entry is acquired.

The “suitable stop posture” is a stop posture recorded in the storage 105 as data having the highest “stop posture evaluation value” in travel processing of the robot apparatus 10 so far.

### (Step S204)

Next, in step S204, the robot apparatus 10 sets the posture of the robot apparatus 10 to the suitable stop posture acquired from the storage 105.

This processing is processing executed by the stop posture control unit 122 of the stop control unit 120 of the robot apparatus 10 illustrated in FIG. 12.

The stop posture control unit 122 inputs, from the suitable stop posture acquirer 121, a “suitable stop posture” having the highest evaluation, which is data in the storage corresponding to the shape of the current traveling surface of the robot apparatus 10, and performs posture control by driving the drive unit 103 of the robot apparatus 10 so as to have a posture matching the input “suitable stop posture”.

### (Step S205)

Next, in step S205, the stop posture control unit 122 determines whether or not the posture of the robot apparatus 10 matches the “suitable stop posture” having the highest evaluation which is data stored in the storage.

In a case where the posture does not match, the posture control in step S204 is continued, and in a case where the posture matches, the processing proceeds to step S206.

### (Step S206)

In a case where determining in step S205 that the posture of the robot apparatus 10 matches the “suitable stop posture” having the highest evaluation which is data stored in the storage, the stop posture control unit 122 stops the robot apparatus 10 in a state where the posture matches the “suitable stop posture” in step S206.

By performing such stop posture control, it is possible to perform stop processing with higher stability.

### 5. Other Embodiments

Next, other embodiments will be described.

In the embodiment described above, the “suitable stop posture” and the “stop posture evaluation value”, which is the evaluation value of the suitable stop posture, to be stored in the storage 105 are recorded for use in association with the “traveling surface shape clustering group” which is the type of the shape of the traveling surface.

However, the “suitable stop posture” and the “stop posture evaluation value”, which is the evaluation value of the suitable stop posture, to be stored in the storage 105 may be generated as data corresponding to not only the type of the shape of the traveling surface but also, for example, the environment in which the robot apparatus 10 travels, and may be recorded in the storage 105 for use.

For example, environment information such as “slipperiness” and “hardness” of the traveling surface on which the robot apparatus 10 travels, whether or not the travel environment of the robot apparatus 10 is an environment where water droplets of rain or the like fall, and a wind speed and a wind direction in the travel environment may be acquired. The acquired environment information may be clustered. The “suitable stop posture” and the “stop posture evaluation value” which is the evaluation value of the suitable stop posture may be calculated in association with an environment information clustering group, and stored in the storage 105 for use.

Note that, in this case, a sensor for acquiring these environment information needs to be attached to the robot apparatus 10.

In such a manner, by calculating the “suitable stop posture” and the “stop posture evaluation value” which is the evaluation value of the suitable stop posture in association with the environment information clustering group and storing the calculated values in the storage 105, it is possible to stop the robot apparatus 10 in a suitable posture according to the travel environment in a case where a stop command is input, by acquiring a suitable stop posture according to the travel environment at that time from the storage 105 and performing stop posture control to match the acquired suitable stop posture.

### 6. Hardware Configuration Example of Robot Apparatus of Present Disclosure

Next, a hardware configuration example of the robot apparatus of the present disclosure will be described.

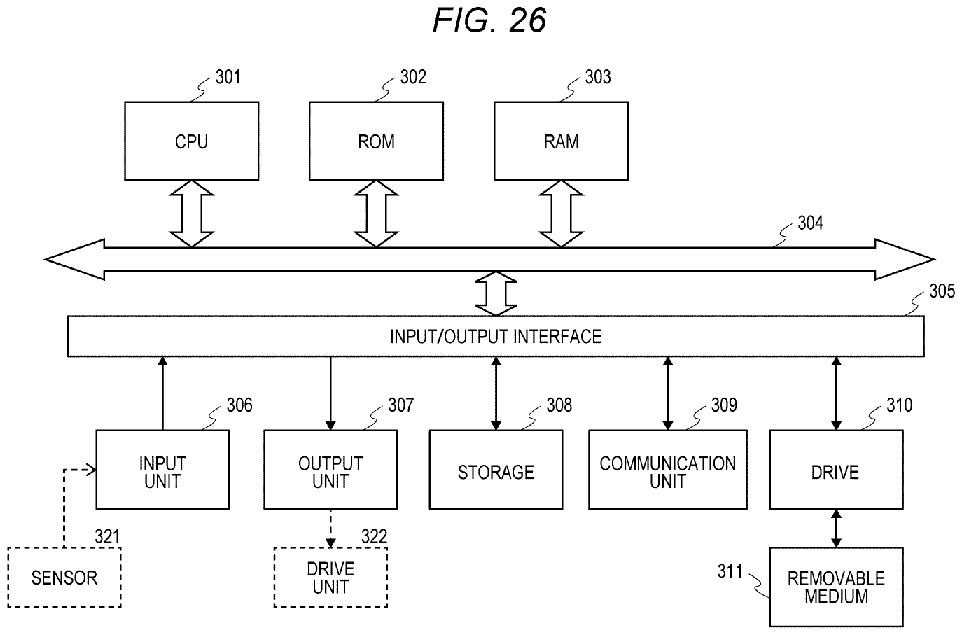

FIG. 26 is a block diagram illustrating an example of a hardware configuration of the robot apparatus of the present disclosure.

A central processing unit (CPU) 301 functions as a data processing unit that performs various types of processing in accordance with a program stored in a read only memory (ROM) 302 or a storage 308. For example, processing according to the sequences described in the embodiment described above is performed. A random access memory (RAM) 303 stores programs, data, and the like to be performed by the CPU 301. The CPU 301, the ROM 302, and the RAM 303 are connected to each other by a bus 304.

The CPU 301 is connected to an input/output interface 305 via the bus 304, and the input/output interface 305 is connected to an input unit 306 including various switches, a keyboard, a touch panel, a mouse, a microphone, and further a status data acquisition unit of a user input unit, a camera, and various sensors 321 such as LiDAR, and the like, and an output unit 307 including a display, a speaker, and the like.

Furthermore, the output unit 307 also outputs drive information for a drive unit 322 that drives the robot and the like.

The CPU 301 inputs commands, status data, and the like input from the input unit 306, executes various types of processing, and outputs processing results to, for example, the output unit 307.

The storage 308 connected to the input/output interface 305 includes, for example, a flash memory, a hard disk, or the like, and stores a program executed by the CPU 301 or various types of data. A communication unit 309 functions as a transmitter and receiver for data communication via a network such as the Internet or a local area network, and communicates with an external device.

Furthermore, in addition to the CPU, a graphics processing unit (GPU) may be provided as a dedicated processing unit for image information and the like input from the camera.

A drive 310 connected to the input/output interface 305 drives a removable medium 311 such as a magnetic disk, an optical disk, a magneto-optical disk, or a semiconductor memory such as a memory card, and records or reads data.

### 7. Summary of Configuration of Present Disclosure

The embodiment of the present disclosure has been described above in detail with reference to specific embodiments. However, it is obvious that those skilled in the art can modify or substitute the embodiments without departing from the gist of the present disclosure. That is, the present invention has been disclosed in the form of exemplification, and should not be interpreted in a limited manner. In order to determine the gist of the present disclosure, the claims should be considered.

Note that the technology herein disclosed can have the following configurations.
(1) A moving apparatus includes a suitable stop posture analyzer that analyzes a suitable stop posture of a walking robot, in which
the suitable stop posture analyzer includes
a traveling surface shape analyzer that analyzes a shape of a traveling surface of the walking robot,
a stop posture analyzer that analyzes stop postures of the walking robot according to the shape of the traveling surface,
a stop posture evaluation value calculator that calculates evaluation values of the stop postures analyzed by the stop posture analyzer, and
a suitable stop posture record updater that records, in a storage, a stop posture having a highest evaluation value among the stop postures of the walking robot according to the shape of the traveling surface.
(2) In the moving apparatus according to (1), the stop posture analyzer analyzes, as the stop posture, a posture of the walking robot at a time when a support polygon that is a polygon including landing points of at least three legs is generated while the walking robot is traveling.
(3) In the moving apparatus according to (1) or (2), the stop posture analyzer analyzes the stop posture by using a detection value of a sensor attached to the walking robot.
(4) In the moving apparatus according to any of (1) to (3), the stop posture analyzer analyzes the stop posture according to the shape of the traveling surface of the walking robot.
(5) In the moving apparatus according to any of (1) to (4), the stop posture evaluation value calculator calculates the evaluation value of the stop posture by using a detection value of a sensor attached to the walking robot.
(6) In the moving apparatus according to any of (1) to (5), the stop posture evaluation value calculator calculates a higher evaluation value as stability of the stop posture is higher.
(7) In the moving apparatus according to any of (1) to (6), the stop posture evaluation value calculator calculates a higher evaluation value as consumed energy of the stop posture is lower.
(8) In the moving apparatus according to any of (1) to (7),
the traveling surface shape analyzer performs clustering processing of classifying the shapes of the traveling surface of the walking robot into a plurality of types, and
the suitable stop posture record updater records, in the storage, the stop posture having the highest evaluation value in unit of a traveling surface shape clustering group which is a result of classification of the shape of the traveling surface by the traveling surface shape analyzer as the suitable stop posture.
(9) In the moving apparatus according to (8), the suitable stop posture record updater records, in the storage, the suitable stop posture corresponding to the traveling surface shape clustering group and an evaluation value of the suitable stop posture.
(10) In the moving apparatus according to (9),
in a case where the stop posture evaluation value corresponding to one traveling surface shape clustering group recorded in the storage is a value lower than an evaluation value of the stop posture newly calculated by the stop posture evaluation value calculator as the stop posture corresponding to the shape of the traveling surface belonging to the one traveling surface shape clustering group,
the suitable stop posture record updater executes data update processing of replacing the stop posture and the stop posture evaluation value corresponding to the one traveling surface shape clustering group recorded in the storage with the stop posture newly analyzed by the stop posture analyzer and the evaluation value newly calculated by the stop posture.
(11) The moving apparatus according to any of (1) to (10) further includes
a storage that stores a suitable stop posture in unit of a traveling surface shape clustering group as a result of classification of the shape of the traveling surface, and
a stop control unit that executes stop control of the walking robot, in which
the stop control unit acquires, from the storage, a suitable stop posture corresponding to the traveling surface shape clustering group to which the shape of the traveling surface on which the walking robot is scheduled to stop belongs, and
the stop control unit executes processing of stopping the walking robot by controlling the posture of the walking robot to match the suitable stop posture.
(12) In the moving apparatus according to (11), the stop control unit executes processing of controlling the posture of the walking robot to match the suitable stop posture and stopping the walking robot in response to reception of a stop command from outside.
(13) A moving apparatus control method is a method executed in a moving apparatus including a suitable stop posture analyzer that analyzes a suitable stop posture of a walking robot, the method including,
by the suitable stop posture analyzer,
traveling surface shape analysis processing of analyzing a shape of a traveling surface of the walking robot,
stop posture analysis processing of analyzing stop postures of the walking robot according to the shape of the traveling surface,
stop posture evaluation value calculation processing of calculating evaluation values of the stop postures analyzed in the stop posture analysis processing, and
suitable stop posture record updating processing of recording, in a storage, a stop posture having a highest evaluation value among the stop postures of the walking robot according to the shape of the traveling surface.
(14) In the moving apparatus control method according to (13),
the moving apparatus includes
the storage that stores the suitable stop posture in unit of a traveling surface shape clustering group as a result of classification of the shape of the traveling surface, and
a stop control unit that executes stop control of the walking robot,
the method including,
by the stop control unit,
acquiring, from the storage, a suitable stop posture corresponding to the traveling surface shape clustering group to which the shape of the traveling surface on which the walking robot is scheduled to stop belongs, and
stopping the walking robot by controlling a posture of the walking robot to match the suitable stop posture.

Note that a series of processing herein described can be executed by hardware, software, or a combined configuration of the both. In a case where processing by software is executed, a program in which a processing sequence is recorded can be installed and executed in a memory in a computer incorporated in dedicated hardware, or the program can be installed and executed in a general-purpose computer capable of executing various types of processing. For example, the program can be recorded in advance in a recording medium. In addition to being installed on a computer from the recording medium, a program can be received via a network such as a local area network (LAN) or the Internet and installed on a recording medium such as an internal hard disk or the like.

Furthermore, the various types of processing herein described may be performed not only in time series as described, but also in parallel or individually in accordance with the processing capability of the device that performs the processing or as necessary. Furthermore, a system herein described is a logical set configuration of a plurality of devices, and is not limited to a system in which devices of respective configurations are in the same housing.

### INDUSTRIAL APPLICABILITY

As described above, a configuration of an embodiment of the present disclosure achieves a configuration in which a suitable posture according to the shape of the traveling surface of the robot is stored in the storage, the suitable posture according to the shape of the traveling surface is acquired from the storage when the robot is to be stopped, and posture control is performed to stop the robot.

Specifically, for example, a suitable stop posture analyzer that analyzes the suitable stop posture of a walking robot executes processing of analyzing the shape of the traveling surface of the walking robot, stop posture analysis processing of analyzing stop postures according to the shape of the traveling surface, stop posture evaluation value calculation processing of calculating evaluation values of the stop postures, and processing of recording, in a storage, a stop posture having a highest evaluation value among the stop postures according to the traveling surface shape. Furthermore, a stop control unit acquires the suitable stop posture corresponding to a traveling surface shape clustering group from the storage, and performs posture control to match a posture of the robot to the suitable stop posture and stop the robot.

This configuration achieves a configuration in which the suitable posture according to the shape of the traveling surface of the robot is stored in the storage, the suitable posture according to the shape of the traveling surface is acquired from the storage when the robot is to be stopped, and the posture control is performed to stop the robot.

### REFERENCE SIGNS LIST

10 Robot apparatus
11 Body
12 Leg portion
13 Camera sensor
14 IMU sensor
15 Leg end pressure sensor
21 Roll axis motor
21a Temperature sensor
21b Torque sensor
22 Hip axis motor
22a Temperature sensor
22b Torque sensor
23 Knee axis motor
23a Temperature sensor
23b Torque sensor
101 Communication unit
102 Travel control unit
103 Drive unit
104 Sensor group
105 Storage
110 Suitable stop posture analyzer
111 Traveling surface shape analyzer
112 Stop posture analyzer
113 Stop posture evaluation value calculator
114 Suitable stop posture record updater
120 Stop control unit
121 Suitable stop posture acquirer
122 Stop posture control
301 CPU
302 ROM
303 RAM
304 Bus
305 Input/output interface
306 Input unit
307 Output unit
308 Storage
309 Communication unit
310 Drive
311 Removable medium
321 Sensor
322 Drive unit

1. A moving apparatus comprising
a suitable stop posture analyzer that analyzes a suitable stop posture of a walking robot, wherein
the suitable stop posture analyzer includes
a traveling surface shape analyzer that analyzes a shape of a traveling surface of the walking robot,
a stop posture analyzer that analyzes stop postures of the walking robot according to the shape of the traveling surface,
a stop posture evaluation value calculator that calculates evaluation values of the stop postures analyzed by the stop posture analyzer, and
a suitable stop posture record updater that records, in a storage, a stop posture having a highest evaluation value among the stop postures of the walking robot according to the shape of the traveling surface.

2. The moving apparatus according to claim 1, wherein
the stop posture analyzer analyzes, as the stop posture, a posture of the walking robot at a time when a support polygon that is a polygon including landing points of at least three legs is generated while the walking robot is traveling.

3. The moving apparatus according to claim 1, wherein
the stop posture analyzer analyzes the stop posture by using a detection value of a sensor attached to the walking robot.

4. The moving apparatus according to claim 1, wherein
the stop posture analyzer analyzes the stop posture according to the shape of the traveling surface of the walking robot.

5. The moving apparatus according to claim 1, wherein
the stop posture evaluation value calculator calculates the evaluation value of the stop posture by using a detection value of a sensor attached to the walking robot.

6. The moving apparatus according to claim 1, wherein
the stop posture evaluation value calculator calculates a higher evaluation value as stability of the stop posture is higher.

7. The moving apparatus according to claim 1, wherein
the stop posture evaluation value calculator calculates a higher evaluation value as consumed energy of the stop posture is lower.

8. The moving apparatus according to claim 1, wherein
the traveling surface shape analyzer performs clustering processing of classifying the shapes of the traveling surface of the walking robot into a plurality of types, and
the suitable stop posture record updater records, in the storage, the stop posture having the highest evaluation value in unit of a traveling surface shape clustering group which is a result of classification of the shape of the traveling surface by the traveling surface shape analyzer as the suitable stop posture.

9. The moving apparatus according to claim 8, wherein
the suitable stop posture record updater records, in the storage, the suitable stop posture corresponding to the traveling surface shape clustering group and an evaluation value of the suitable stop posture.

10. The moving apparatus according to claim 9, wherein
in a case where the stop posture evaluation value corresponding to one traveling surface shape clustering group recorded in the storage is a value lower than an evaluation value of the stop posture newly calculated by the stop posture evaluation value calculator as the stop posture corresponding to the shape of the traveling surface belonging to the one traveling surface shape clustering group,
the suitable stop posture record updater executes data update processing of replacing the stop posture and the stop posture evaluation value corresponding to the one traveling surface shape clustering group recorded in the storage with the stop posture newly analyzed by the stop posture analyzer and the evaluation value newly calculated by the stop posture.

11. The moving apparatus according to claim 1, further comprising:
the storage that stores a suitable stop posture in unit of a traveling surface shape clustering group as a result of classification of the shape of the traveling surface; and
a stop control unit that executes stop control of the walking robot, wherein
the stop control unit acquires, from the storage, a suitable stop posture corresponding to the traveling surface shape clustering group to which the shape of the traveling surface on which the walking robot is scheduled to stop belongs, and
the stop control unit executes processing of stopping the walking robot by controlling the posture of the walking robot to match the suitable stop posture.

12. The moving apparatus according to claim 11, wherein
the stop control unit executes processing of controlling the posture of the walking robot to match the suitable stop posture and stopping the walking robot in response to reception of a stop command from outside.

13. A moving apparatus control method executed in a moving apparatus including
a suitable stop posture analyzer that analyzes a suitable stop posture of a walking robot, the method comprising:
by the suitable stop posture analyzer,
traveling surface shape analysis processing of analyzing a shape of a traveling surface of the walking robot;
stop posture analysis processing of analyzing stop postures of the walking robot according to the shape of the traveling surface;
stop posture evaluation value calculation processing of calculating evaluation values of the stop postures analyzed in the stop posture analysis processing; and
suitable stop posture record updating processing of recording, in a storage, a stop posture having a highest evaluation value among the stop postures of the walking robot according to the shape of the traveling surface.

14. The moving apparatus control method according to claim 13, wherein
the moving apparatus includes
the storage that stores the suitable stop posture in unit of a traveling surface shape clustering group as a result of classification of the shape of the traveling surface, and
a stop control unit that executes stop control of the walking robot,
the method comprising:
by the stop control unit,
acquiring, from the storage, a suitable stop posture corresponding to the traveling surface shape clustering group to which the shape of the traveling surface on which the walking robot is scheduled to stop belongs; and
stopping the walking robot by controlling a posture of the walking robot to match the suitable stop posture.
